(19) United States
(12) Patent Application Publication
(10) Pub. No.: US 2016/0157084 A1
(43) Pub. Date: Jun. 2, 2016

(54) COMMUNICATION CONTROL APPARATUS, COMMUNICATION SYSTEM, AND COMMUNICATION CONTROL METHOD

(71) Applicant: FUJITSU LIMITED, Kawasaki-shi (JP)

(72) Inventor: Koji TSUBOUCHI, Yamato (JP)

(21) Appl. No.: 14/930,521

(22) Filed: Nov. 2, 2015

(30) Foreign Application Priority Data
Nov. 28, 2014 (JP) 2014-241682

(51) Int. Cl. H04W 8/02

(52) U.S. Cl. CPC H04W 8/02; H04W 88/16

(57) ABSTRACT

A communication control apparatus including: a network interface configured to make the communication control apparatus be deployed in a specified core network operated by a specified carrier provider, the specified core network in which a plurality of gateway apparatus are deployed, the plurality of gateway apparatus including at least one other gateway apparatus, each of the at least one other gateway apparatus being operated by each of at least one other carrier provider, and a processor configure to: identify, when a terminal requests to utilize the specified core network but has not subscribed to the specified core network, a gateway apparatus to make the terminal communicate with an external network using packets, the gateway apparatus being identified from among the at least one gateway apparatus based on first information, the gateway apparatus being operated by another carrier provider to which the terminal has subscribed.

### CROSS-REFERENCE TO RELATED APPLICATION

This application is based upon and claims the benefit of priority of the prior Japanese Patent Application No. 2014-241682, filed on Nov. 28, 2014, the entire contents of which are incorporated herein by reference.

### FIELD

The embodiment discussed herein is related to a communication path control method and an information processing apparatus.

### BACKGROUND

A mobile communication system, which is prescribed by 3rd-Generation Partnership Project (3GPP), is one of the mobile phone networks. For example, the standard of the wireless communication of the mobile communication system prescribed by the 3GPP includes wideband code division multiple access (W-CDMA), high-speed downlink packet access (HDSPA), long term evolution (LTE), LTE-advanced (LTE-A), or the like.

The ability that enables the subscriber of a certain telecommunications carrier (referred to as a “carrier” or a “carrier provider”) to receive communication services using the network of another carrier at a cooperation destination outside of the service area of the telecommunications carrier is called “roaming”.

A method called home routed is one of the roaming methods prescribed by the 3GPP. In the home routed method, a data communication path is formed such that data from a terminal passes through the network operated by a carrier at a subscription destination (referred to as a “home network”) from the network operated by a carrier at the cooperation destination (referred to as a “visited network”).

Japanese National Publication of International Patent Application No. 2011-511519 and Japanese Laid-open Patent Publication No. 2008-289110 are examples of the related art.

### SUMMARY

According to an aspect of the invention, a communication control apparatus includes a network interface configured to make the communication control apparatus be deployed in a specified core network operated by a specified carrier provider, the specified core network being one of a plurality of core networks, the specified carrier provider being one of a plurality of carrier providers, each of the plurality of core networks being operated by each of the plurality of carrier providers, each of the plurality of core networks being coupled to an external network, the specified core network in which a plurality of gateway apparatus are deployed, each of the plurality of gateway apparatus forwarding packets between the specified core network and the external network, the plurality of gateway apparatus including a specified gateway apparatus and at least one other gateway apparatus, the specified gateway apparatus being operated by the specified carrier provider, each of the at least one other gateway apparatus being operated by each of at least one other carrier provider of the plurality of carrier providers, and a processor configure to: identify, when a terminal requests to utilize the specified core network but has not subscribed to the specified core network, a gateway apparatus to make the terminal communicate with the external network using the packets, the gateway apparatus being identified from among the at least one gateway apparatus based on first information, the gateway apparatus being operated by another carrier provider to which the terminal has subscribed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of an LTE network which is an example of a 3GPP mobile communication system;

FIG. 2 is a diagram illustrating a data communication path when a UE is roaming on a visited network using a home routed method;

FIG. 3 is a diagram illustrating the data communication path when the UE is roaming using a local breakout method;

FIG. 4 is an explanatory view illustrating a selection procedure of a P-GW when the local breakout method is performed;

FIG. 5 is a diagram illustrating an example in which the P-GW and the service network of a first carrier are virtualized in a second carrier network;

FIG. 6 is a diagram illustrating an example in which an S-GW, the P-GW, and the service network of the first carrier are virtualized in the second carrier network;

FIG. 7 is a diagram illustrating an example of the configuration of a system (communication path control system) in which the network facility (VNF) of the first carrier is deployed in the second carrier network and which forms the communication path using the VNF;

FIG. 8 is a diagram illustrating an example of the functional block configuration of a VNF deployment server, an operating system, and a VNF selection server;

FIG. 9 is a table illustrating an example of the data structure of a database which is preserved in a preservation unit;

FIG. 10 is a diagram illustrating the flow from when the VNF of the first carrier is deployed in the station of the second carrier to when VNF information, which is completely deployed in the VNF selection server, is registered;

FIG. 11 is a diagram illustrating a modification example of the VNF operating system;

FIG. 12 is a table illustrating an example of the data structure of a database in order to search for the IP address of the P-GW;

FIG. 13 is a diagram illustrating an example of the data structure of a database in order to search for the IP address of the S-GW;

FIG. 14 is a diagram illustrating an example of the hardware configuration of an information processing apparatus (computer) which operates as the VNF selection server;

FIG. 15 is a sequence diagram illustrating a roaming procedure according to an application example 1;

FIG. 16 is a sequence diagram illustrating an application example 1-1 which is the modification example of the application example 1;

FIG. 17 is a sequence diagram illustrating a roaming procedure according to an application example 2;

FIG. 18 is a sequence diagram illustrating an application example 2-1 which is the modification example of the application example 2;

FIG. 19 is a sequence diagram illustrating a roaming procedure according to an application example 3;

FIG. 20 is a sequence diagram illustrating an application example 3-1 which is the modification example of the application example 3;

FIG. 21 is a sequence diagram illustrating a roaming procedure according to an application example 4;

FIG. 22 is a sequence diagram illustrating an application example 4-1 which is the modification example of the application example 4;

FIG. 23 is a sequence diagram illustrating a roaming procedure according to an application example 5;

FIG. 24 is a sequence diagram illustrating an application example 5-1 which is the modification example of the application example 5;

FIG. 25 is a sequence diagram illustrating a procedure when the UE moves after the application example 5 and the application example 5-1 are performed;

FIG. 26 is a sequence diagram illustrating a roaming procedure according to an application example 6;

FIG. 27 is a sequence diagram illustrating an application example 6-1 which is the modification example of the application example 6;

FIG. 28 is a sequence diagram illustrating a procedure when the UE moves after the application example 6 and the application example 6-1 are performed;

FIG. 29 is a sequence diagram illustrating a roaming procedure according to an application example 7;

FIG. 30 is a sequence diagram illustrating an application example 7-1 which is the modification example of the application example 7;

FIG. 31 is a sequence diagram illustrating a procedure when the UE moves after the application example 7 and the application example 7-1 are performed;

FIG. 32 is a sequence diagram illustrating a roaming procedure according to an application example 8;

FIG. 33 is a sequence diagram illustrating an application example 8-1 which is the modification example of the application example 8;

FIG. 34 is a sequence diagram illustrating a procedure when the UE moves after the application example 8 and the application example 8-1 are performed;

FIG. 35 is a sequence diagram illustrating a roaming procedure according to an application example 9; and

FIG. 36 is a sequence diagram illustrating an application example 9-1 which is the modification example of the application example 9.

### DESCRIPTION OF EMBODIMENT

However, in a home routed method, the communication path of data passes through a single home network, and thus there is a possibility that an inefficient communication path is formed as a result.

An object of an aspect of the embodiment is to provide a technology which is capable of forming an efficient communication path for the terminal of a first carrier which performs communication in the service area of a second carrier.

Hereinafter, an embodiment will be described with reference to the accompanying drawings. The configuration of the embodiment is only an example, and the embodiment is not limited thereto.

### Example of Configuration of Mobile Communication System

### Comparison Example

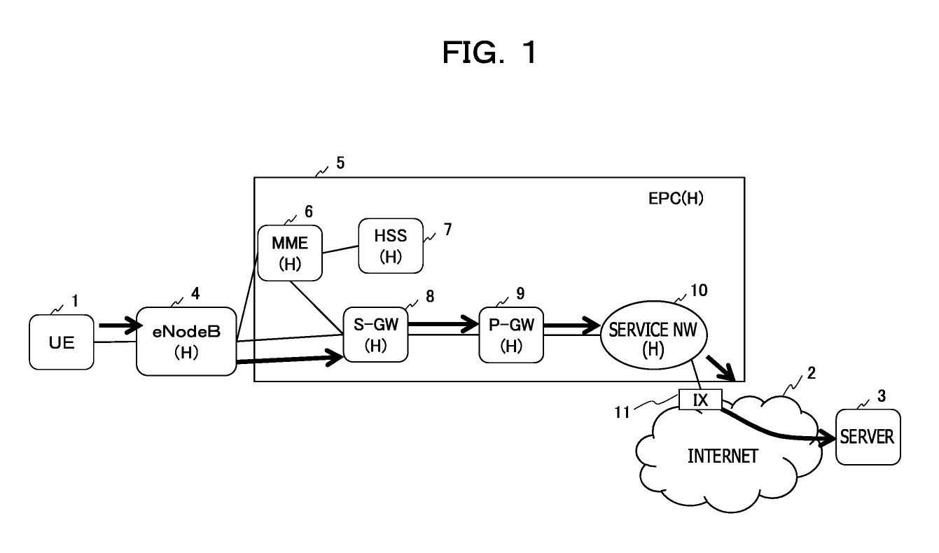

FIG. 1 is a diagram illustrating an example of the configuration of a mobile communication system (referred to as an LTE network) based on LTE or LTE-A which is an example of a 3GPP mobile communication system as a comparison example. FIG. 1 illustrates a case in which a wireless terminal (called a user equipment (UE)) 1 performs data communication with a server 3, which is a communication partner (correspondent node), on the Internet 2 through the LTE network.

The LTE network includes a wireless network and a core network. In the wireless network, a wireless base station (called an “eNodeB”, hereinafter, described as a “base station”) 4 is deployed. In the core network 5, a mobility management entity (MME) 6, a home subscriber server (HSS) 7, a serving gateway (S-GW) 8, a packet data network gateway (P-GW) 9, and a service network (NW) 10 are deployed.

The MME 6 performs the call control of a wireless terminal (UE) and selection between the S-GW and the P-GW. The HSS 7 maintains a database for information relevant to a subscriber, and is used for certification and location registration of the UE 1.

The S-GW 8 transmits traffic (or packets), which is received from the UE through the base station 4, to the P-GW. The P-GW 9 is a gateway which is a junction point with an external network (called a packet data network (PDN)), such as the Internet 2, and transmits the traffic from the S-GW 8 to the service network 10.

The service network 10 is a network which is uniquely set by a telecommunications carrier (refer to a “carrier”) which provides the mobile communication system and in which a prescribed network service set by the carrier according to a policy is performed.

A plurality of base stations 4 are deployed in a state in which the base stations 4 are geographically dispersed. In FIG. 1, one base station 4 is illustrated as an example. In addition, although the S-GW 8, the P-GW 9, and the service network 10 are illustrated one by one in FIG. 1, a plurality of S-GWs 8, P-GWs 9, and service networks 10 are provided in the core network 5.

Traffic between the UE 1 and the server 3 flows in the following path. The traffic from the UE 1 is transmitted to the S-GW 8 through the base station 4. The S-GW 8 transmits the traffic, which is received from the base station 4, to the P-GW 9 (namely, the S-GW 8 forwards the traffic). The P-GW 9 transmits the traffic, which is received from the S-GW 8, to the service network 10 (namely, the P-GW 9 forwards the traffic).

At this time, the P-GW 9 performs a prescribed operation relevant to the traffic. For example, the P-GW 9 adds up traffic throughput (data quantity). Otherwise, the P-GW 9 limits a communication speed according to the traffic throughput (data quantity). However, the prescribed operation of the P-GW 9 is not limited thereto.

Various communication devices (machines) relevant to prescribed network services, which are provided to the UE 1, are installed in the service network 10. The communication devices (machines) include a gateway for the Internet 2, that is, a gateway which connects the Internet to the service network (service network) 10 through the switching system 11. Further, it is possible for the service network 10 to include at least one communication device (machine) which is selected from among a web cache server, a content filtering server that performs a process associated with the age limit, a mail server, and the like.

However, the communication devices (machines), which are included in the service network 10, are not limited thereto, and are determined by taking the type of a network service to be provided to the UE 1 into consideration. Meanwhile, in the embodiment, the type of the service is treated as the type of the service network 10 to which the service is provided, and is identified using the address of the P-GW which is linked with the service network 10.

When the UE 1 is connected to the LTE network (establishes a call), the MME 6 selects the P-GW 9 according to the service network 10 which is used by the UE 1. When a plurality of service networks 10 are provided, the P-GWs 9 corresponding to the respective service networks 10 are set up in advance.

The UE 1 uses the P-GW 9, which is selected by the MME 6 when the UE 1 is connected to the LTE network, until being cut from the LTE network. In addition, when the UE 1 is connected to the LTE network, the MME 6 selects the S-GW 8 according to the location of the UE 1. Further, after the UE 1 is connected to the LTE network, the MME 6 selects the S-GW 8 again according to the movement of the UE 1, and the path of the traffic is changed.

As described above, when the MME 6 selects the S-GW 8 and the P-GW 9 according to the UE 1, the communication path of the UE 1 is set up. The communication path between the P-GW 9 and the service network 10 is statically set up (determined) using, for example, a setup file or the like included in the P-GW 9.

Outside of the service area of the LTE network of a currently subscribed telecommunications carrier (hereinafter, referred to as a “first carrier”), it is possible for the UE 1 to perform roaming using the LTE network of another telecommunications carrier (hereinafter, referred to as a “second carrier”) which cooperates with the first carrier. With regard to the UE 1, the LTE network of the first carrier is a home network and the LTE network of the second carrier is a visited network (visited NW).

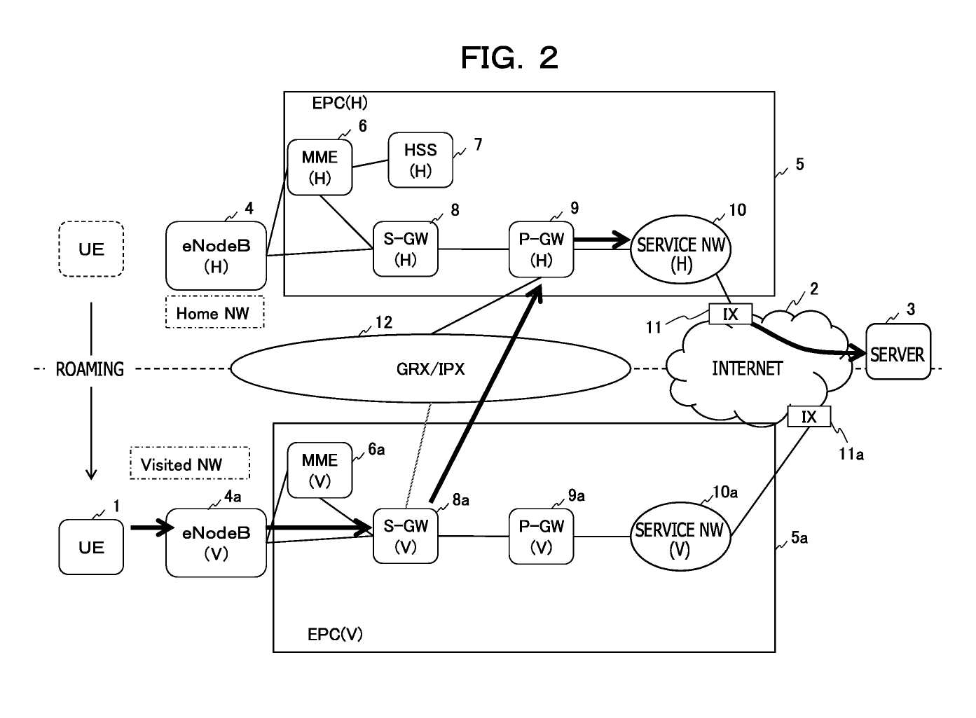

FIG. 2 illustrates a data communication path when the UE 1 is roaming on a visited network (the LTE network of the second carrier, referred to as a “second carrier network”) in a home routed method which is defined in 3GPP. The data communication path (the path of traffic) is indicated by thick line arrows.

In FIG. 2, similarly to the home network, the visited network includes a base station 4a which forms the wireless network of the second carrier, and the core network 5a of the second carrier. The core network 5a includes an MME 6a, an S-GW 8a, a P-GW 9a, and a service network 10a. The service network 10a is connected to the Internet 2 through a switching system 11a. Meanwhile, the HSS of the core network 5a is not illustrated in the drawing. In addition, in FIG. 2, “(H)” indicates that a communication device belongs to the home network (first carrier) and “(V)” indicates that the communication device belongs to the visited network (second carrier).

When the home routed method is performed, traffic, which is transmitted from the UE 1, is transmitted to the P-GW 9 in the home network (core network 5) from the S-GW 8a of the visited network (core network 5a) through a GRX/IPX (GPRS Roaming eXchange/IP exchange) 12, which is the network for the roaming service provider. The traffic finally reaches the server 3 from the service network 10 through the Internet 2. In the home routed method, the communication path of the UE 1, which is the roaming terminal, returns to the single home network, and exits to the Internet 2 (external network). It is inefficient to set up such a communication path. For example, when a home network is present in Japan and a visited network and the server 3 are present in America, the data communication path of the UE 1 returns to the single Japan from America and then returns to America again through the Internet 2.

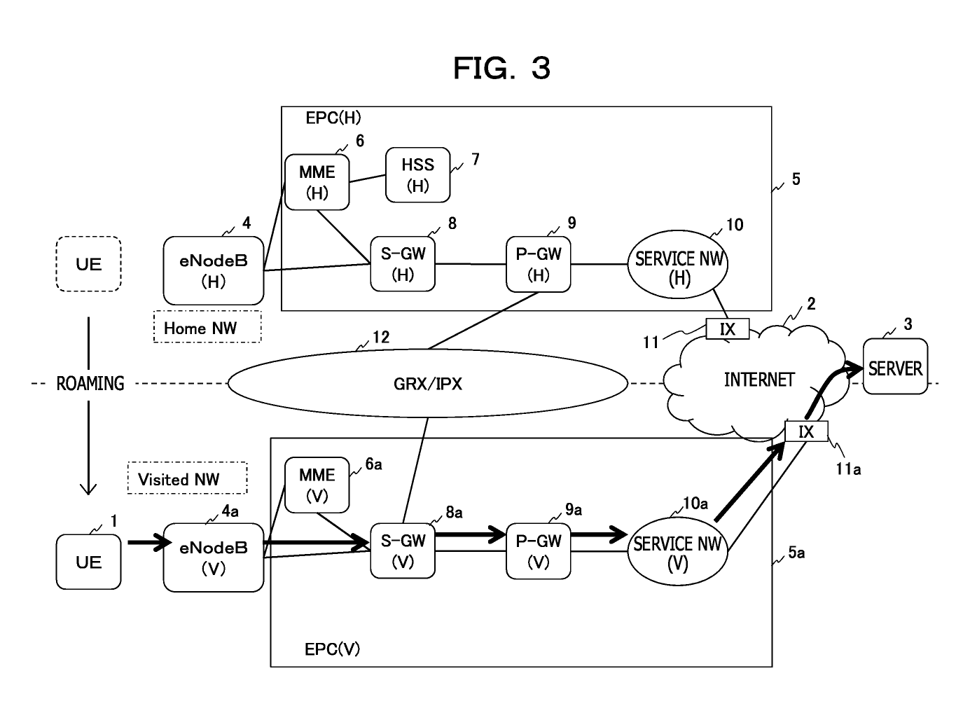

In 3GPP, a roaming method, which is called a local breakout method is defined in addition to the home routed method. FIG. 3 illustrates a data communication path when the UE 1 performs roaming by the local breakout method using the second carrier network illustrated in FIG. 2. In the local breakout method, the P-GW 9 in the visited network is selected as the P-GW, through which the traffic of the UE 1 passes, instead of the P-GW 9 in the home network. The traffic reaches the server 3 through the service network 10a of the second carrier and the Internet 2.

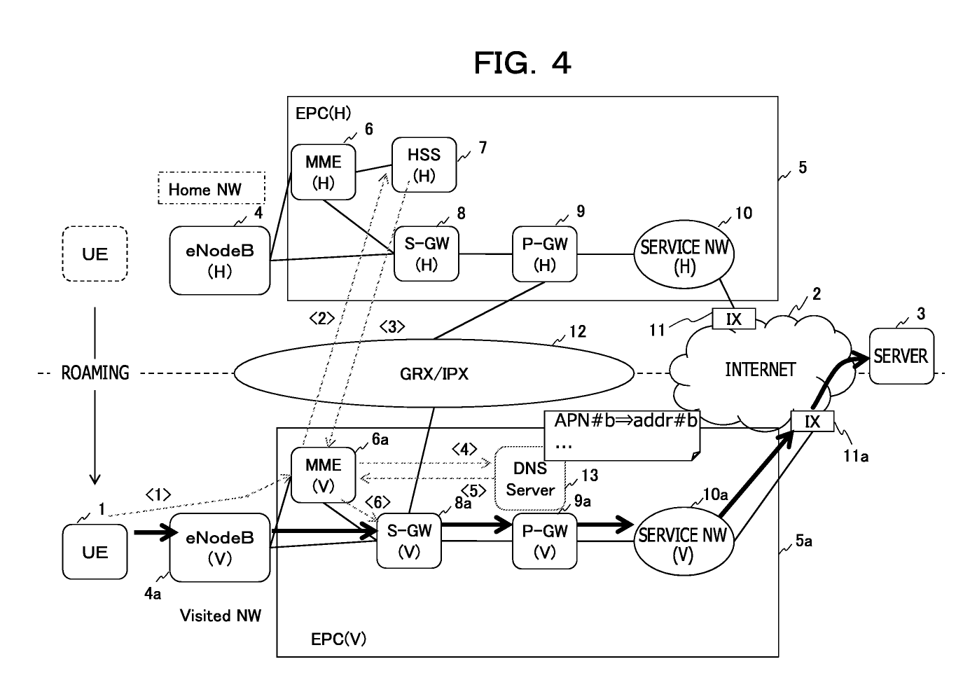

FIG. 4 is an explanatory view illustrating the selection procedure of the P-GW when the local breakout method is performed. In FIG. 4, the selection procedure of the P-GW will be described as follows.

[Procedure 1]

When the UE 1 performs roaming in the LTE network of the second carrier, the UE 1 first transmits a message for requesting a connection to the LTE network (or for utilizing the LTE network) of the second carrier to the MME 6a through the base station 4a (<1> in FIG. 4). The message for a connection demand includes an access point name (APN), a subscriber ID, and the like. The APN is the identifier of the connection destination of the UE 1, and is, for example, the identifier of the service network 10. In the example of FIG. 4, it is assumed that an “APN#b” which is the identifier of the service network 10a is included in the connection demand as the APN.

[Procedure 2]

When the MME 6a receives the connection demand, the MME 6a transmits a certification demand for the UE1 to the HSS 7 of the first carrier (<2> in FIG. 4).

[Procedure 3]

The HSS 7 searches a database for subscriber information corresponding to the subscriber ID of the UE 1 which is included in the certification demand, and performs a certifying process between the HSS 7 and the UE 1. The HSS 7 sends a response message, which includes the result of the certification, to the MME 6a (<3> in FIG. 4).

[Procedure 4]

When the certification is successful, the MME 6a selects the S-GW (the S-GW 8a in FIG. 4) of the second carrier, to which the traffic of the UE 1 is transmitted, and transmits a message for name resolution to the Domain Name System (DNS) server 13 (<4> in FIG. 4) based on the APN (APN#b) which is received from the UE 1.

[Procedure 5]

The DNS server 13 returns the IP address (Addr#b) of the P-GW 9a corresponding to the APN (APN#b) to the MME 6a (<5> in FIG. 4).

[Procedure 6]

The MME 6a notifies the S-GW 8a, which is selected in procedure 5, of the IP address of the P-GW 9a to which the traffic of the UE 1 is transmitted (<5> in FIG. 4). Therefore, the S-GW 8a sets up a communication path for the P-GW 9a, which is designated by the MME 6a, and the UE 1. At this time, the communication path between the P-GW 9a and the service network 10a is statically set up as described above. The communication procedure for set up and the connection process of the UE 1 (call set up procedure) thereafter are performed in conformity with the rules described in “3GPP TS23.401”. Here, the details of the procedure will not be described.

When the above-described procedures 1 to 6 are performed, it is possible for the UE 1 to perform data communication with the communication partner (server 3) while not passing through the home network.

In the local breakout method, in order to form a communication path for the data communication between the UE 1 and the server 3, the facilities (the S-GW 8a, the P-GW 9a, and the service network 10a) of the LTE network of the second carrier (also referred to as a “second carrier network”) are used. Therefore, the content of control, which is performed for the data communication of the UE 1, the type of collected information, and the like depend on the policies of the second carrier.

Therefore, when the UE 1 does not perform roaming or performs the home routed method, it is not limited to performing the data communication control (access control, bandwidth control, or the like), which is performed on the UE 1, or collection of log information in the second carrier network. Accordingly, in a case of roaming, there is a possibility that the content of control pertaining to the UE 1 is limited to a part or information, which can be acquired relevant to the data communication pertaining to the UE 1, is limited.

In the embodiment, a mobile communication system, which is capable of avoiding the defects of the above-described home routed method and the local breakout method, will be described.

### Example of Configuration of Mobile Communication System According to Embodiment

In the mobile communication system according to the embodiment, the network facilities (the communication device and the service network) of the first carrier are installed in the service area (for example, the second carrier network) of the second carrier using a network functions virtualization (NFV). In the second carrier network, the network facilities of the first carrier are deployed, for example, in the station in which the network facilities of the second carrier are installed.

The NFV technology is a method of implementing the function of the communication device, which controls a network, as software and executing the function on the virtual machine (VM) which is generated on a general-purpose server. In the embodiment, a network function, which is included in a machine that forms the S-GW, the P-GW, and the service network of the first carrier, is realized as software (virtualized). Further, a virtualized network function (VNF) is operated on a virtual machine, which is generated on the general-purpose server, as the machine that forms the S-GW, the P-GW, and the service network of the first carrier.

For example, in the general-purpose server, middleware is installed in order to generate virtual machines which are called hyper-visors and VNF application programs, which operate as the S-GW, the P-GW, and the service network, are mounted. When a processor (for example, a central processing unit (CPU)), which is included in the general-purpose server, executes the hyper-visors and the application programs, it is possible for the general-purpose server to demonstrate network functions (functions of the gateway for connecting to the Internet 2) which are included in the S-GW, the P-GW, and the service network.

Meanwhile, the VNFs may be mounted such that one general-purpose server operates as the S-GW, the P-GW, and the service network. Further, the S-GW, the P-GW, and the service network may be mounted on individual general-purpose servers. Otherwise, two of the S-GW, the P-GW, and the service network may be mounted on the general-purpose server and the remaining one may be mounted on another general-purpose server. In addition, the number of each of the S-GW, the P-GW, and the service network which are mounted on one general-purpose server is arbitrary.

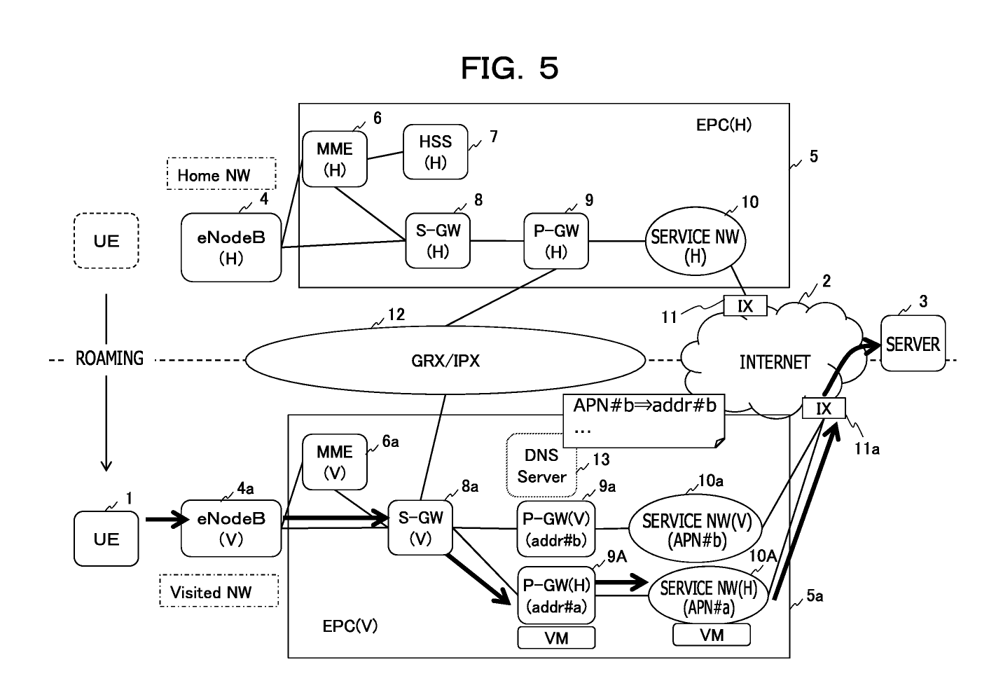

FIG. 5 illustrates an example in which the P-GW and the service network of the first carrier are virtualized in the second carrier network. When the second carrier network (core network 5a) corresponds to NFV, the network functions of the P-GW 9 and the service network 10, which are used until this point when the home routed method is performed, are operated on the virtual machines (VMs). Therefore, a state is made in which a virtual P-GW 9A and a virtual service network 10A are deployed in the second carrier network (the service area of the second carrier).

In this case, when the MME 6a selects the P-GW 9A as a P-GW, which corresponds to the connection demand (APN (APN#a)) of the UE 1, and notifies the S-GW 8a of the IP address (addr#a) of the P-GW 9A, the communication path of the UE 1, which passes through the S-GW 8, the P-GW 9A, and the service network 10A, is constructed. As described above, the MME 6a controls the formation of the communication path.

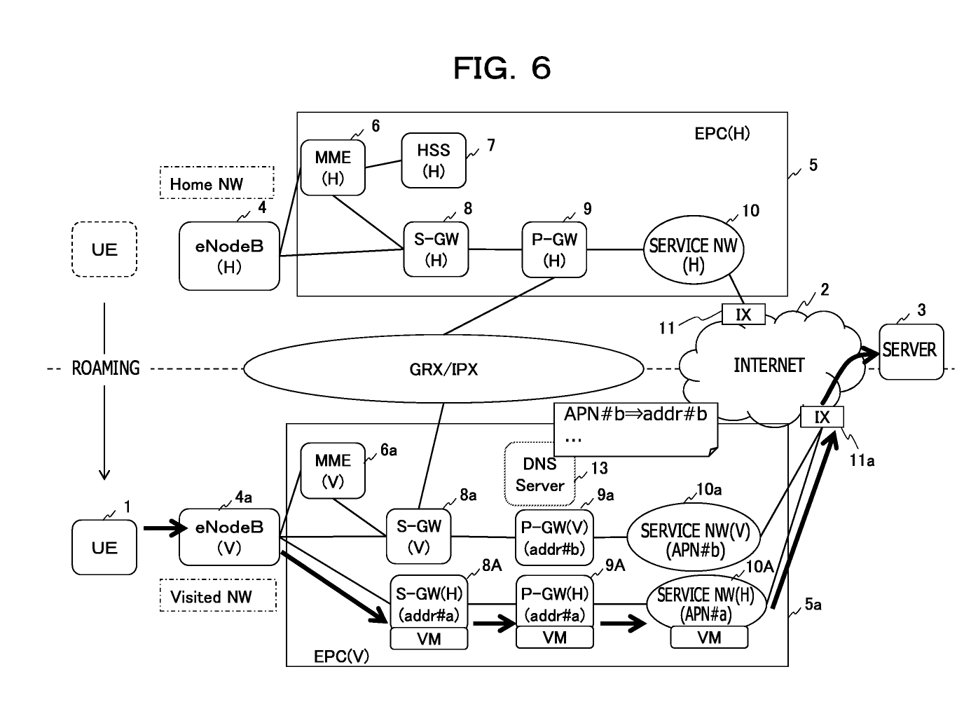

FIG. 6 illustrates an example in which the S-GW, the P-GW, and the service network of the first carrier are virtualized in the second carrier network. In the example of FIG. 6, network functions, which are respectively included in the S-GW 8, the P-GW 9 and the service network 10 of the first carrier, are virtualized in the second carrier network (core network 5a). Therefore, a state is made in which the S-GW 8A, the P-GW 9A, and the service network 10A of the first carrier are installed in the second carrier network.

When the MME 6a receives the connection demand from the UE 1, the MME 6a selects the S-GW 8A and notifies the S-GW 8A of the IP address of the P-GW 9A. Accordingly, a communication path including the S-GW 8A, the P-GW 9A, and the service network 10A is formed in the core network 5a.

According to the examples illustrated in FIG. 5 and FIG. 6, the communication path of the data communication of the UE 1 does not pass through the P-GW 9 and the service network 10, and thus it is possible to avoid the inefficiency of the communication path unlike the home routed method. In addition, the communication path passes through the P-GW 9A and the service network 10A of the first carrier, and thus it is possible to perform the same control and data collection as in a case in which the communication path passes through the P-GW 9 and the service network 10.

When roaming is performed as illustrated in FIG. 5 and FIG. 6, in order to form the data communication path of the UE 1, the network functions of the first carrier are operated as VNFs in the second carrier network. Further, when the UE 1 performs roaming on the second carrier network, the UE 1 performs data communication using the VNFs. Therefore, the VNFs of the first carrier are deployed in advance in the second carrier network (core network 5a), and a setting is performed such that the VNFs, which are deployed when the UE 1 is connected to the second carrier network, are selected. In addition, as illustrated in the example of FIG. 6, when the S-GW is operated as the VNF of the first carrier, the S-GW is selected again as occasion calls when the UE 1 moves between the base stations.

Meanwhile, the Internet 2 is an example of an “external network”. The MME 6a is an example of a “machine which controls the communication path of a terminal”. The S-GW 8A, the P-GW 9A, and the service network 10A are respective examples of the “communication devices of the first carrier”. The HSS 7 is an example of a “subscriber information management machine”.

### Example of Configuration of Communication Path Control System

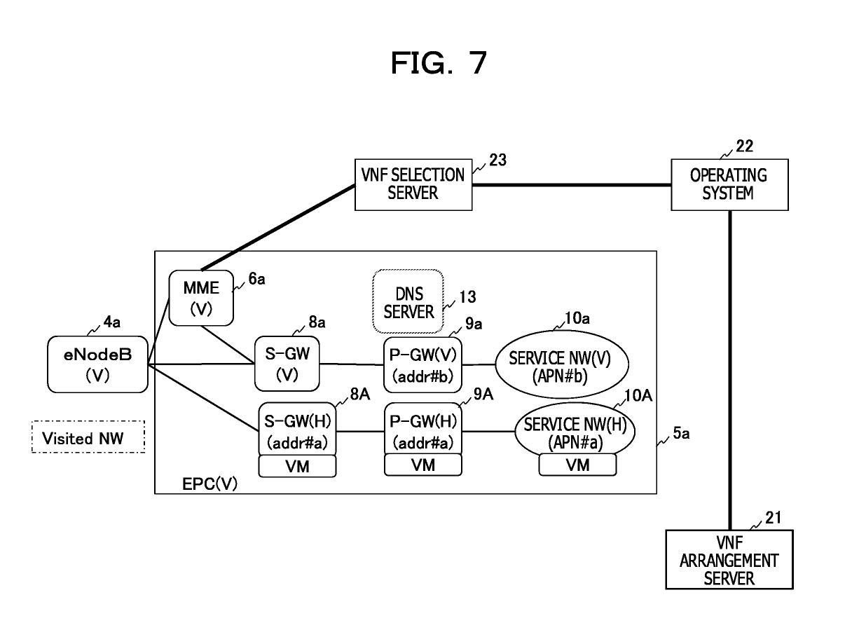

FIG. 7 is a diagram illustrating an example of the configuration of a system (communication path control system) in which the network facilities (VNFs) of the first carrier are deployed in the second carrier network and which forms a communication path using the VNFs. The communication path control system includes a VNF deployment server 21, an operating system 22, and a VNF selection server 23. The VNF selection server 23 is an example of a “server” and an “information processing apparatus”. The operating system 22 is an example of “another device”.

When the VNFs of the first carrier are deployed in the station of the second carrier (service area) and the UE 1 connects to the second carrier network, the MME 6a makes inquiries at the VNF selection server 23 about a VNF to be used. Accordingly, in order to form a data communication path relevant to the UE 1, completely deployed VNFs (the S-GW 8A and the P-GW 9A) are selected.

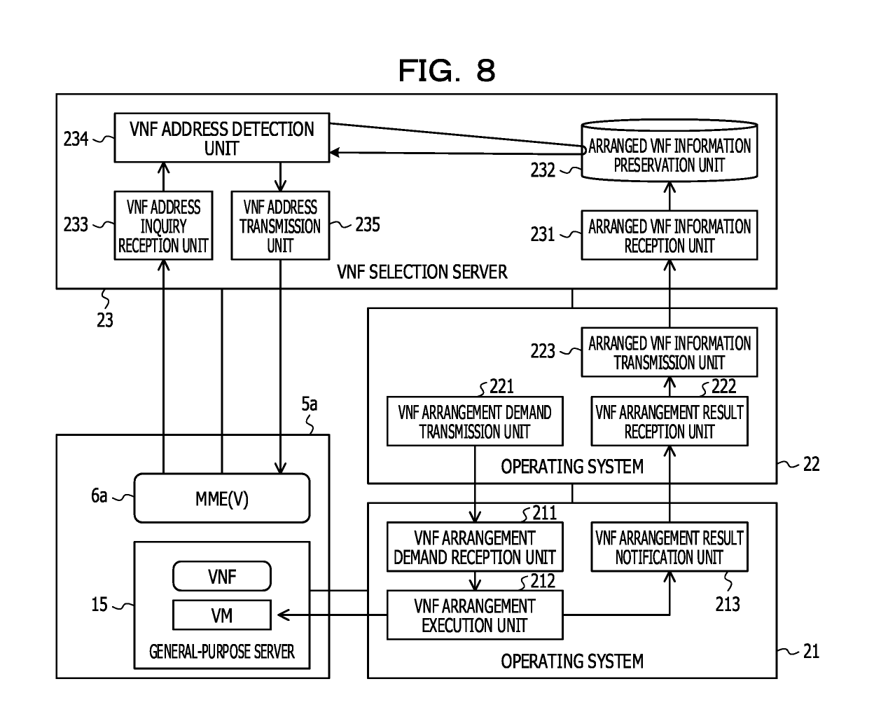

FIG. 8 is a diagram illustrating an example of the functional block configuration of the VNF deployment server 21, the operating system 22, and the VNF selection server 23. In FIG. 8, the VNF deployment server 21 includes a VNF deployment demand reception unit 211, a VNF deployment execution unit 212, and a VNF deployment result notification unit 213.

The VNF deployment demand reception unit 211 receives a VNF deployment demand from the operating system 22. The VNF deployment execution unit 212 deploys VNFs corresponding to the VNF deployment demand, which is received by the VNF deployment demand reception unit 211, on the general-purpose server 15 in the station of the second carrier.

The VNF deployment result notification unit 213 notifies the operating system 22 of the results of VFN deployment. The notification content includes addresses which are assigned to the deployed VNF (the S-GW 8A and the P-GW 9A). The addresses are, for example, IP addresses. However, a configuration may be applied in which addresses or identifiers are applied instead of the IP addresses and in which the IP addresses are indexed from the addresses or identifiers using a separate correspondence table. VNF addresses (an S-GW address and a P-GW address) are examples of “information indicative of the communication devices of the first carrier”.

The operating system 22 includes a VNF deployment demand transmission unit 221, a VNF deployment result reception unit 222, and a deployed VNF information transmission unit 223. The VNF deployment demand transmission unit 221 transmits information, which is relevant to the VNFs demanded to be deployed, to the VNF deployment server 21 according to the policy of the first carrier.

The VNF deployment result reception unit 222 receives the results of the VFN deployment from the VNF deployment server 21. The deployed VNF information transmission unit 223 transmits the IP addresses of the deployed VNFs (the S-GW 8A and the P-GW 9A), which are received by the VNF deployment result reception unit 222, and the ID (first carrier ID: the identifier of the first carrier) of the telecommunications carrier (first carrier), which deploys the VNFs, to the VNF selection server 23.

The VNF selection server 23 includes a deployed VNF information reception unit 231, a deployed VNF information preservation unit 232, a VNF address inquiry reception unit 233, a VNF address detection unit 234, and a VNF address transmission unit 235.

The deployed VNF information reception unit 231 preserves (stores) the IP addresses of the VNFs (the S-GW 8A and the P-GW 9A), which are received from the operating system 22, and the first carrier ID in the deployed VNF information preservation unit 232.

The VNF address inquiry reception unit 233 receives inquiries about the IP addresses of the VNFs, which are used for the data communication of the UE 1, from the MME 6a. The inquiries include the first carrier ID. The first carrier ID, which is included in the inquiries, is acquired when the MME 6a acquires, for example, the first carrier ID included in the connection demand from the UE 1. Otherwise, it is possible for the MME 6a to acquire the first carrier ID from another communication device such as an HSS 7.

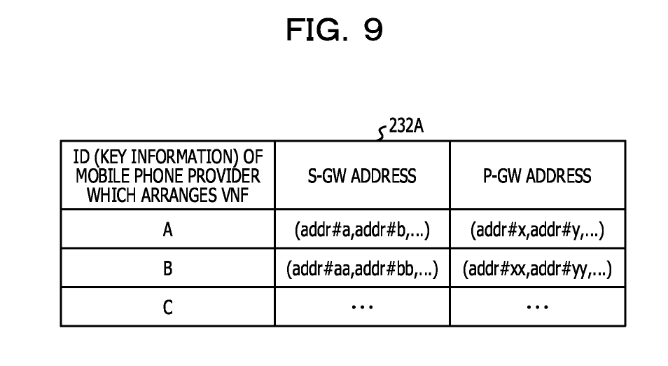

The deployed VNF information preservation unit 232 includes a database. When the database is searched, the first carrier ID is used as a search key. FIG. 9 illustrates an example of the data structure of a database 232A which is preserved in the preservation unit 232. As illustrated in FIG. 9, the database 232A stores the addresses of the S-GW and the P-GW in association with the first carrier ID. Meanwhile, in FIG. 9, information relevant to the VNF, which operates as the service network 10A, is not preserved. The search key is an example of a “key which is related to a terminal”.

When the VNF address inquiry reception unit 233 receives the inquiries, the VNF address detection unit 234 searches for (detects) the IP addresses of the VNFs (the S-GW and the P-GW) corresponding to the first carrier ID with reference to the deployed VNF information preservation unit 232.

At this time, when a plurality of IP addresses of the VNFs corresponding to the first carrier ID are registered, one of the plurality of IP addresses is randomly selected (detected). Otherwise, one of the plurality of IP addresses may be selected (detected) according to prescribed priorities. Meanwhile, when a VNF corresponding to a selection target is the S-GW, the S-GW may be selected based on a tracking area code ((TAC): a code corresponding to an ID acquired by grouping base stations) which indicates an area to which the base station 4a connected to the UE 1 belongs. The TAC may be used as the search key instead of the first carrier ID or may be used as the search key together with the first carrier ID. The TAC is an example of an “area identifier”. The respective first carrier ID and the TAC are examples of the “search key”.

The VNF address transmission unit 235 sends (supplies) the IP addresses of the VNFs, which are searched for by the VNF address detection unit 234, to the MME 6a. In contrast, when there is no VNF address corresponding to the results of detection performed by the detection unit 234, the transmission unit 235 provides a notification that there is no correspondence VNF address to the MME 6a.

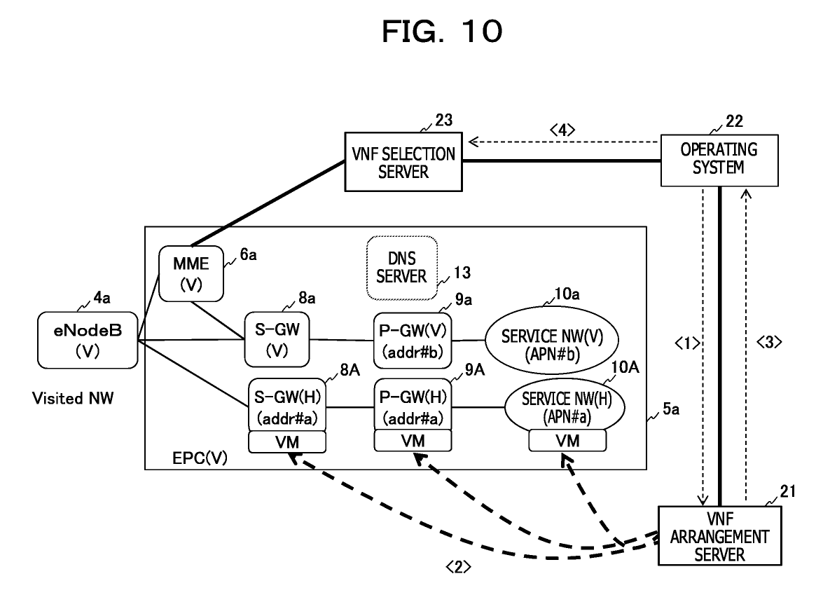

FIG. 10 is a diagram illustrating the flow until the VNF of the first carrier is deployed in the station of the second carrier and VNF information, which is completely deployed in the VNF selection server 23, is registered. In FIG. 10, first, the operating system 22 instructs the VNF deployment server 21 to deploy the VNFs on the station of the second carrier (sends an deployment demand) (<1> in FIG. 10).

Secondly, the VNF deployment server 21 deploys the VNFs corresponding to the deployment demand in the station of the second carrier according to the instruction from the operating system 22 (<2> in FIG. 10). The example of FIG. 10 illustrates an example in which the S-GW 8A, the P-GW 9A, and the service network 10A are deployed. There is a case in which the S-GW 8A is not deployed.

Thirdly, the VNF deployment server 21 notifies the operating system of the IP addresses (VNF addresses) which are assigned to the deployed VNFs (the S-GW and the P-GW) (<3> in FIG. 10). Fourthly (finally), the operating system 22 notifies the VNF selection server 23 of the VNF addresses and the first carrier ID (<4> in FIG. 10), and the VNF selection server 23 preserves the VNF addresses and the first carrier ID in the database 232A.

According to the above-described embodiment, the virtualized P-GW 9A and the service network 10A are deployed in the service area of the second carrier, and a data communication path, which passes through the virtualized P-GW 9A and the service network 10A and reaches the Internet 2, is formed (FIG. 5). Otherwise, the virtualized S-GW 8A, the P-GW 9A, and the service network 10A are deployed in the service area of the second carrier, and a data communication path, which passes through the virtualized S-GW 8A, the P-GW 9A, and the service network 10A and reaches the Internet 2, is formed (FIG. 6). With this, similarly to the home routed method, it is possible to avoid an inefficient data communication path being formed. Meanwhile, data, which flows through the data communication path, includes various data such as text, images, videos, and sounds.

### Modification Example

In the examples described with reference to FIGS. 8 to 10, the VNF selection server 23 does not take the contract situation of a subscriber which is using the UE 1 into consideration. The contract situation includes information indicative of whether or not the VNFs of the first carrier, which are deployed on the station of the second carrier, may be used, and information indicative of the type of a service network which is designated by the UE 1 using the APN.

Therefore, when the UE of the first carrier is connected to the second carrier network, in which the VNFs of the first carrier are deployed when connecting to the second carrier network, the UE uses the VNFs regardless of the contract situation of the subscriber of the UE 1. In addition, in the examples described with reference to FIGS. 8 to 10, when the UE of the first carrier performs roaming connection to the second carrier network, the deployed service network is used for the station of the second carrier regardless of the type of the service network which is designated by the UE using the APN. Therefore, modification examples as follows are considered.

### Modification Example 1

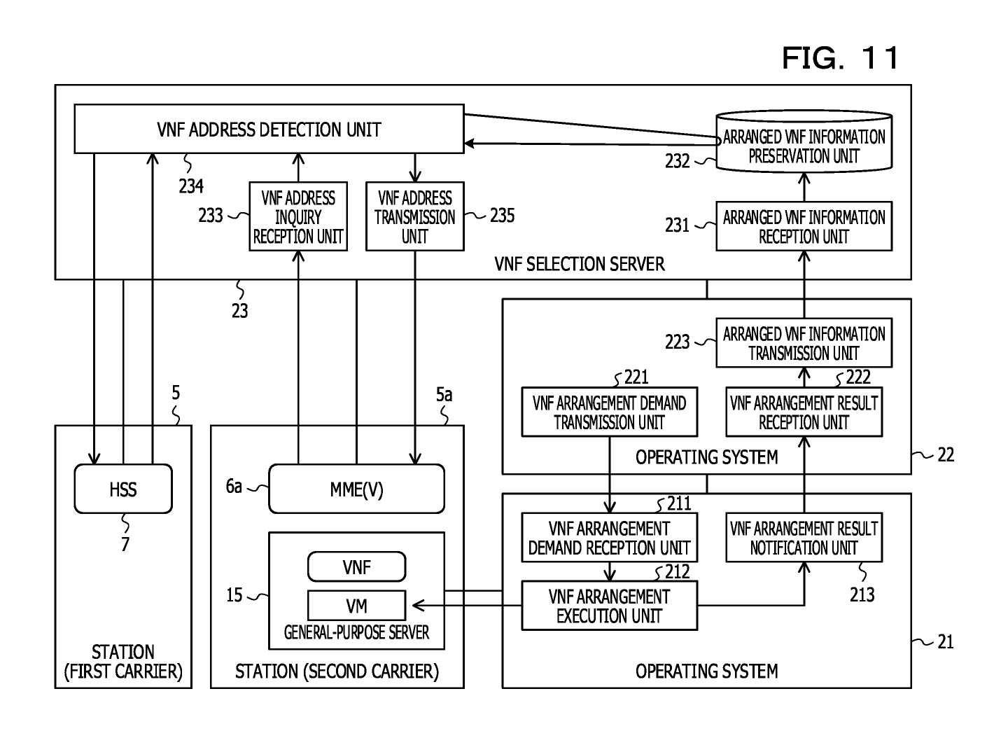

FIG. 11 is a diagram illustrating a modification example of the communication path control system. When the contract situation of the subscriber of the UE is taken into consideration, the VNF selection server 23 further performs operations as follows:

(a) The VNF address inquiry reception unit 233 receives a UE subscriber ID (identifier of the UE (subscriber)) which is included in the inquiry. The subscriber ID is an example of the “identifier of a terminal”.

(b) The VNF address detection unit 234 makes inquiries at the HSS 7 of the first carrier about whether or not the VNFs, which are deployed in the station of the second carrier, may be used using the subscriber ID. The HSS 7 searches for subscriber information corresponding to the subscriber ID which is acquired from the VNF selection server 23. The subscriber information includes information indicative of whether or not the subscriber is permitted to use the VNFs. The HSS 7 determines whether or not the VNFs are usable for the UE 1 by checking the information. The HSS 7 sends the results of determination (the VNFs may be used or the VNFs may not be used) to the VNF selection server 23.

(c) When the VNF address detection unit 234 receives a notification that the VNFs may be used from the HSS 7 as the results of the inquiries made at the HSS 7, the VNF address detection unit 234 searches for the addresses of the VNFs with reference to the preservation unit 232. In contrast, when the VNF selection server 23 receives a notification that the VNFs may not be used from the HSS 7, the VNF address transmission unit 235 provides a notification that the VNFs may not be used to the MME 6a. In this case, the MME 6a forms the data communication path using, for example, a normal roaming method (the home routed method or the local breakout method).

### Modification Example 2

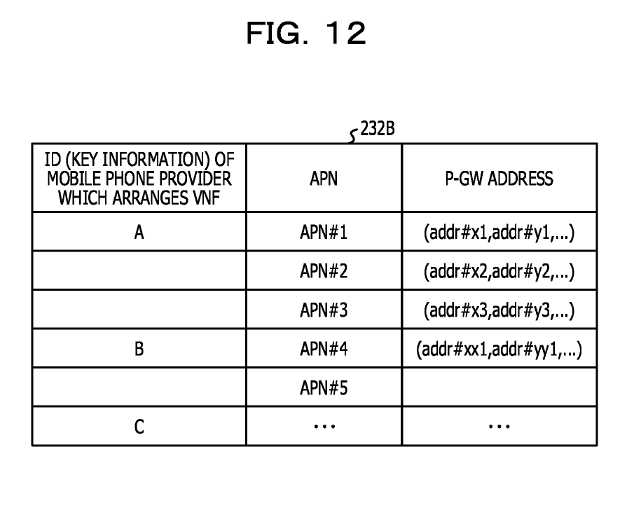

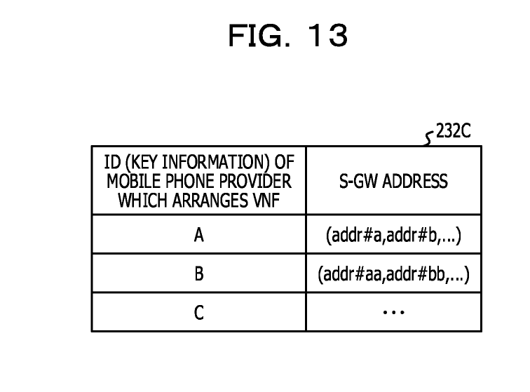

In addition, when the type of the service network which is designated by the UE using the APN is taken into consideration, the VNF selection server 23 is deformed as described below. FIG. 12 and FIG. 13 illustrate examples of the data structures of the databases which are stored in the preservation unit 232.

As illustrated in FIG. 12 and FIG. 13, the database is divided into a database 232B for searching for the IP address of the P-GW and a database 232C for searching for the IP address of the S-GW.

As illustrated in FIG. 12, the database 232B is searched for the first carrier ID and the IP address of the P-GW corresponding to the APN. The IP address of the P-GW is prepared according to the type of the service network which is designated using the APN. The APN is an example of the “identifier of the service network”.

As illustrated in FIG. 13, in the database 232C, the IP address of the S-GW corresponding to the first carrier ID is stored. The reason for this is that the S-GW is selected without depending on the APN.

When the database 232B and the database 232C, which are illustrated in FIG. 12 and FIG. 13, are used, for example, the VNF selection server 23 illustrated in FIG. 8 performs an operation as described below in addition to the above-described operation.

That is, the VNF address inquiry reception unit 233 in the VNF selection server 23 acquires the APN which is included in the inquiries from the MME 6a. The APN is designated by the UE and is included in, for example, the connection demand of the UE.

When the VNF, which is the inquiry target, is the P-GW, the VNF address detection unit 234 reads the first carrier ID, which is included in the inquiries, and the IP address of the VNF (P-GW) corresponding to the APN with reference to the database 232B of the preservation unit 232. That is, the first carrier ID and the APN are used as the search keys of the database 232B. The APN is an example of the “search key”.

In contrast, when the VNFs, which are the inquiry targets, are the S-GW and the P-GW, the database 232C is searched for (read) the IP address of the S-GW corresponding to the first carrier ID in addition to the above-described IP address of the P-GW.

It is possible to combine the configuration of the above-described modification example 2 with the configuration of the modification example 1. Therefore, it is possible to select the VNFs while taking both the contract situation of the subscriber and the type of the service network into consideration.

According to the modification example 2, the IP address of the P-GW 9A is determined such that the service network 10A is connected to the UE 1 according to the APN. Accordingly, it is possible to supply a network service equivalent to the prescribed network service, which is supplied in the home network, to the UE 1.

In addition, according to the embodiment, the network facilities of the first carrier are used for data communication when roaming is performed. Therefore, it is possible to perform the same control (for example, access control, bandwidth control, or the like), which is performed in the home network, or information collection (for example, log information collection) with regard to the data communication of the UE 1.

Meanwhile, in the embodiment, the VNFs, which are operated on the general-purpose server, are illustrated as the network facilities (communication devices or machines) of the first carrier. However, the fact that the communication devices or the machines are the virtual network functions (VNF) is not a demanded condition. That is, the network facilities (communication devices) of the first carrier, which are deployed in the service area of the second carrier, may be actual machines.

### Example of Hardware Configuration

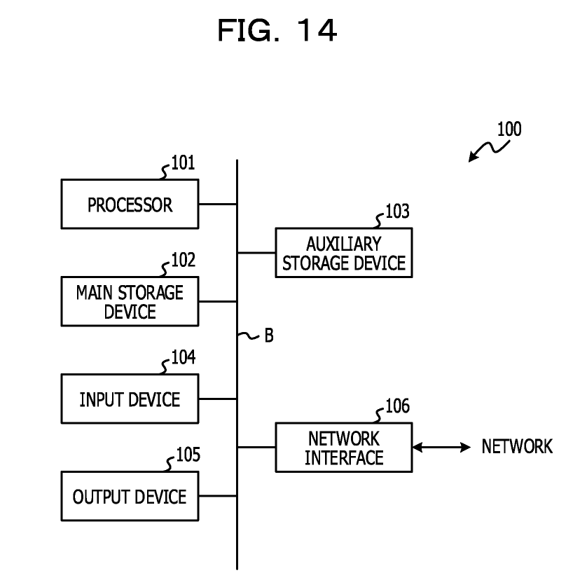

FIG. 14 is a diagram illustrating an example of the hardware configuration of an information processing apparatus (computer) 100 which operates as the VNF selection server 23. It is possible to apply, for example, a dedicated server machine, a general-purpose computer (for example, a personal computer (PC), a workstation, or the like), or the like as the information processing apparatus.

The information processing apparatus 100 includes a connection processor 101, a main storage device 102, an auxiliary storage device 103, an input device 104, an output device 105, and a network interface (NIF) 106 which are connected to each other through a bus B.

The input device 104 is, for example, a pointing device, such as a keyboard or a mouse, or the like. Data which is input from the input device 104 is supplied to the processor. The output device 105 outputs the results of a process performed by the processor 101. The output device 105 includes, for example, a sound output device, such as a speaker, a display, and a printer.

The NIF 106 is an interface circuit which performs input and output of information with a network. The NIF 106 includes at least one of an interface which is connected to a wired network and an interface which is connected to a wireless network. The NIF 106 includes, for example, a network interface card (NIC), a local area network (LAN) card, a wireless LAN card, or the like. Data, which is received by the NIF 106, or the like is sent to the processor 101.

The auxiliary storage device 103 stores various programs and data which is used by the processor 101 when each of the programs is executed. The auxiliary storage device 103 is, for example, a nonvolatile memory such as an erasable programmable ROM (EPROM), a hard disk drive, a flash memory, or a solid state drive (SSD). The auxiliary storage device 103 stores, for example, an operating system (OS), a data accumulation destination determination program, and other various application programs. The auxiliary storage device 103 may include a portable recording medium, such as a USB memory, and a disc recording medium such as a CD or a DVD.

The main storage device 102 supplies a storage area or an operating area, to which the programs stored in the auxiliary storage device 103 are loaded, to the processor 101 or is used as a buffer. The main storage device 102 is formed using, for example, a semiconductor memory such as a random access memory (RAM). There is a case in which the main storage device 102 includes a read only memory (ROM).

The processor 101 is, for example, a central processing unit (CPU) or a microprocessor (MPU). The processor 101 loads the various programs, which are stored in the auxiliary storage device 103, to the main storage device 102 and executes the programs. Accordingly, the processor 101 performs various processes such that the information processing apparatus 100 operates as the VNF selection server. The processor is not limited to one processor and a plurality of processors may be provided.

The processor 101 is an example of a “control machine”. The main storage device 102 and the auxiliary storage device 103 are examples of a “storage device” and a “computer readable recording medium”, respectively. In addition, a part or the entirety of a process which is performed by the processor 101 may be implemented by hardware logic using a semiconductor device. The semiconductor device includes, for example, the combination of a programmable logic device (PLD), such as a field programmable gate array (FPGA), an application specific integrated circuit (ASIC), a large scale integrated (LSI) circuit, an IC and a gate circuit, and an electrical and electronic circuit.

The processor 101 performs a process as described below by executing a program. That is, the processor 101 performs a process of storing the VNF information (the VPN address and the first carrier ID) in the preservation unit 232 as the reception unit 231. In addition, the processor 101 performs a process of acquiring the inquiries (the first carrier ID and the APN) as the reception unit 233.

In addition, the processor 101 performs a process of searching the preservation unit 232 for the VNF addresses (the IP address of the P-GW or the IP addresses of the S-GW and the P-GW) as the detection unit 234. In addition, the processor 101 makes inquiries at the HSS 7 as the detection unit 234. Further, the processor 101 performs a process of notifying the MME of the VNF addresses as the transmission unit 235. In addition, the preservation unit 232 causes the main storage device 102 or the auxiliary storage device 103 to store the VNF addresses.

It is possible to use the information processing apparatus 100 as the VNF deployment server 21. In this case, various programs are stored (installed) in the auxiliary storage device 103 of the information processing apparatus 100 such that the processor 101 performs operations as the reception unit 211, the VNF deployment execution unit 212, and the notification unit 213.

In addition, it is possible to use the information processing apparatus 100 as the operating system 22. In this case, programs are stored (installed) in the auxiliary storage device 103 of the information processing apparatus 100 such that the processor 101 performs operations as the transmission unit 221, the reception unit 222, and the transmission unit 223.

In addition, it is possible for the information processing apparatus 100 to use the general-purpose server 15. In this case, application programs are stored in the auxiliary storage device 103 of the information processing apparatus 100 such that the above-described hyper-visors, the OS, and the VNFs (the S-GW, the P-GW, and machines in the service network) are executed.

Further, it is possible to use the information processing apparatus 100 as the MME 6 (6a), the HSS 7, the S-GW 8 (8a), the P-GW 9 (9a), the machines (server or the like) in the service network 10 (10a), and the DNS server 13.

When the information processing apparatus 100 is used as the MME 6 (6a), various programs are stored in the auxiliary storage device 103 such that the information processing apparatus 100 operates as the MME 6 (6a) according to the execution of the processor 101.

When the information processing apparatus 100 is used as the HSS 7, various programs, the subscriber database, and the like are stored in the auxiliary storage device 103 such that the information processing apparatus 100 operates as the HSS 7 according to the execution of the processor 101.

When the information processing apparatus 100 is used as the S-GW 8 (8a), various programs are stored in the auxiliary storage device 103 such that the information processing apparatus 100 operates as the S-GW 8 (8a) according to the execution of the processor 101.

When the information processing apparatus 100 is used as the P-GW 9 (9a), various programs are stored in the auxiliary storage device 103 such that the information processing apparatus 100 operates as the P-GW 9 (9a) according to the execution of the processor 101.

When the information processing apparatus 100 is used as the communication device (machine) of the service network 10, various programs are stored in the auxiliary storage device 103 such that the information processing apparatus 100 operates as the communication device (machine) according to the execution of the processor 101.

Meanwhile, the examples illustrated in FIG. 8 and FIG. 11 illustrate examples in which the MME 6a of the second carrier is used to control the formation of the data communication path of the UE 1. However, the MME of the first carrier may be virtualized in the station of the second carrier (service area), and the virtualized MME may make inquiries at the VNF selection server 23 and may perform control instead of the MME 6a. In this case, for example, the base station 4a transmits a connection demand (calling demand) from the connected UE 1 to the virtualized MME.

In addition, the example illustrated in FIG. 11 illustrates an example in which the HSS 7 is included in the first carrier network (core network 5). Instead of this, the virtualized HSS of the first carrier may be deployed in the station of the second carrier (service area) and the VNF selection server 23 may make inquiries at the virtualized HSS.

### Application Example

It is possible to install the VNF selection server 23 as an independent machine. Otherwise, it is possible to mount the VNF selection server 23 on the information processing apparatus (computer) which operates as each of the HSS, the MME, and the DNS server. The mounting is performed by installing, for example, various programs in the information processing apparatus such that the information processing apparatus operates as the VNF selection server 23.

In addition, when the P-GW and the service network are deployed in the service area of the second carrier as the deployment target VNFs, a case in which the P-GW and the service network are deployed in another company station together with the S-GW is considered. In this case, further, it is considered that the VNF selection server 23, which returns the address of the S-GW, and the MME are mounted (shared) on the same information processing apparatus and the VNF selection server 23, which returns the address of the P-GW, and the HSS are mounted (shared) on the same information processing apparatus. That is, a configuration, in which the VNF selection server 23 is divided into a VNF selection server for the S-GW address and a VNF selection server for the P-GW address, is considered.

Hereinafter, with regard to the above-described pattern, a procedure which is performed when the UE 1 performs roaming on the second carrier network will be described according to an application example. Meanwhile, in the description of the application example, an example, in which both the contract situation of the subscriber which uses the UE 1 and the type of the service network which is designated by the UE 1 using the APN are considered, will be described.

### Application Example 1

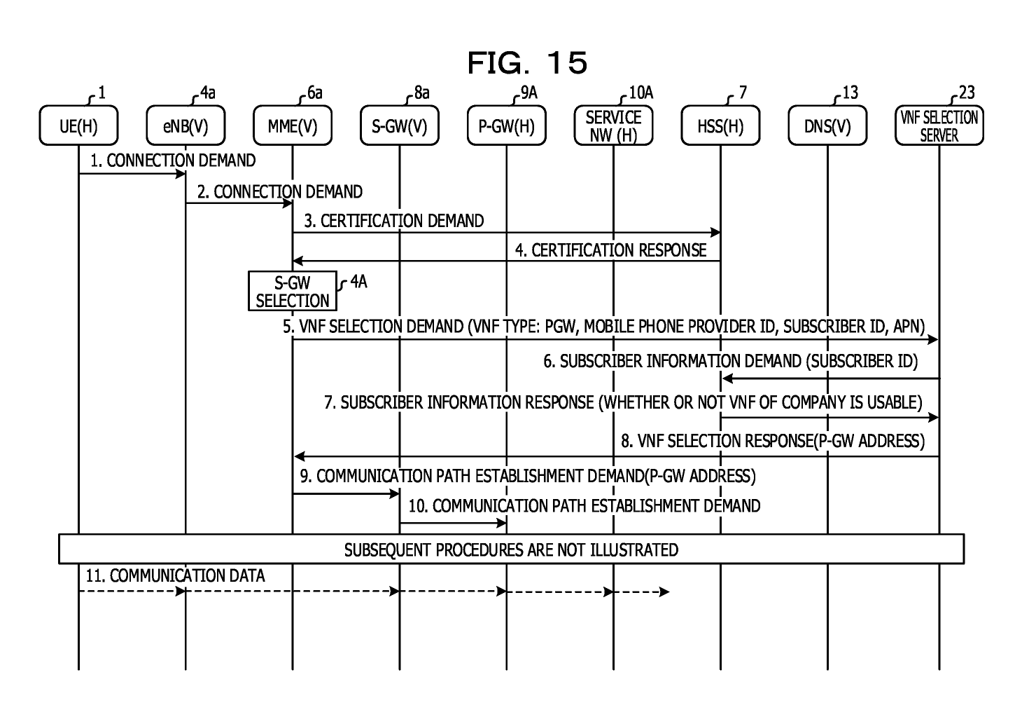

As an application example 1, a procedure, performed when roaming is performed in a pattern in which target VNFs deployed in the service area of the second carrier are the P-GW and the service network (refer to FIG. 5) and the VNF selection server 23 is an independent machine, will be described. FIG. 15 is a sequence diagram illustrating a roaming procedure according to the application example 1.

(Procedure 1)

In FIG. 15, when the UE 1, which is a terminal subscribed to the first carrier, performs roaming on the visited network (second carrier network), the UE 1 sends a connection demand (calling demand) message to the base station 4a. The connection demand includes a first carrier ID, a subscriber ID (the identifier of the UE 1), and an APN which is designated by the UE 1.

(Procedures 2 to 4)

The base station 4a transmits a connection demand, which is received from the UE 1, to the MME 6a (procedure 2). The MME 6a, which receives the connection demand, sends the certification demand message of the UE 1 to the HSS 7 of the first carrier (procedure 3). The HSS 7, which receives the certification demand, performs a certifying process between the HSS 7 and the UE 1, and sends a certification result message to the MME 6a (procedure 4).

(Procedure 4A and Procedure 5)

The MME 6a, which receives the result of the certification, performs an S-GW selection process using an existing method when certification is successful (procedure 4A). In addition, the MME 6a sends a VNF selection demand message to the VNF selection server 23 in order to solve the IP address of the P-GW of the first carrier (procedure 5). The VNF selection demand includes the fact that the type of the selection target VNF is the P-GW, the first carrier ID, the subscriber ID, and the APN.

(Procedure 6)

The VNF selection server 23 (the processor 101 of the information processing apparatus 100 which operates as the VNF selection server 23), which receives the VNF selection demand, makes inquiries at the HSS 7 about whether or not the VNF is usable (subscriber information demand). The inquiries include the subscriber ID.

(Procedure 7)

The HSS 7 searches the subscriber database for the subscriber information based on the subscriber ID, and provides a response (usable or unusable: subscriber information response), which indicates whether or not the VNF is usable and which is included in the subscriber information, to the VNF selection server 23.

(Procedure 8)

When the VNF is permitted to be used by the results of the inquiries made at the HSS 7, the VNF selection server 23 (processor 101), which receives the response from the HSS 7, refers to the preservation unit 232 (the database 232B (FIG. 12)) based on the type of the selection target VNF included in the inquiries. The VNF selection server 23 (processor 101) reads (searches for) the first carrier ID, which is included in the inquiries, and the IP address of the P-GW (P-GW address) corresponding to the APN from the database 232B. Further, the VNF selection server 23 (processor 101) sends (supplies) the P-GW address to the MME 6a.

(Procedure 9)

The MME 6a, which receives the P-GW address, sends a communication path establishment demand message to the S-GW 8a which includes the S-GW address (the IP address of the S-GW) acquired in the S-GW selection process. The communication path establishment demand includes the P-GW address.

(Procedure 10)

The S-GW 8a, which receives the communication path establishment demand, sends the communication path establishment demand message to the P-GW 9A which includes the P-GW address. Thereafter, a communication path between the P-GW 9A and the service network 10A, which is the connection destination of the UE 1 designated using the APN, is established. Further, a wireless path is established between the base station 4a and the UE 1.

Details of a procedure (call establishment procedure) thereafter will not be described. In brief, the S-GW 8a sends communication path establishment completion to the MME 6a. The MME 6a supplies a demand for establishing a wireless communication path with the UE 1 to the base station 4a. When the wireless communication path is established between the base station 4a and the UE 1, the MME 6a sends a communication path update demand to the S-GW 8a. The S-GW 8a connects the communication path and the wireless communication path between the S-GW 8a and the base station 4a by performing a communication path update process.

In addition, a gateway which is included in the service network 10 is connected to the Internet 2 through the switching system 11a, and a path with the server 3 (FIG. 5) which is the communication partner of the UE 1 is established. In this manner, the data communication path (UE 1->base station 4a->S-GW 8a->P-GW 9A->service network 10A->the Internet 2->server 3) between the UE 1 and the server 3 is established.

Further, it is possible for the UE 1 to be connected to the Internet 2 using the communication facility (VNF) of the first carrier, which is deployed in the service area of the second carrier, and to send data to the server 3 (procedure 11).

### Application Example 1-1

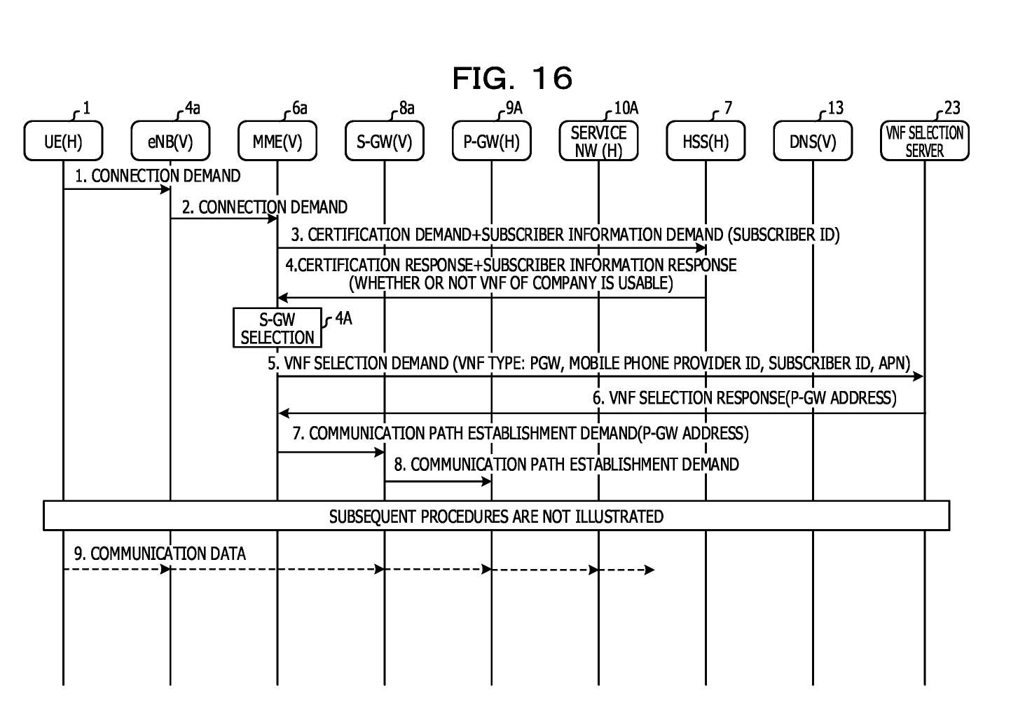

In the above-described procedures according to the application example 1, the HSS 7 is accessed twice in the procedures 3 and 6. A modification example of the application example 1, in which the HSS 7 is accessed only once, will be described as an application example 1-1 with reference to FIG. 16.

(Procedures 1 to 3)

In FIG. 16, a procedure 1 and a procedure 2 according to the application example 1-1 are the same as in the application example 1. The MME 6a simultaneously sends a certification demand for the UE 1 and a subscriber information demand to the HSS 7 (procedure 3). The certification demand and the subscriber information demand include the subscriber ID.

(Procedure 4)

The HSS 7, which receives the certification demand and the subscriber information demand, performs a process of certifying the UE 1 based on the subscriber ID. When the certification is successful, the HSS 7 sends information, which is indicative of whether or not the VNF is usable and which is determined based on the subscriber information, together with the result of the certification to the MME 6a.

(Procedure 5)

When the VNF is usable by the results of the inquiries made at the HSS 7, the MME 6a performs a process which is the same as the process described in the procedure 5 according to the application example 1.

(Procedure 6)

The VNF selection server 23 (processor 101) searches for the first carrier ID and the P-GW address corresponding to the APN with regard to the VNF, about which the inquiries are made, by referring to the preservation unit 232. The VNF selection server 23 (processor 101) sends (supplies) the P-GW address to the MME 6a. In this manner, the inquiries about whether or not the VNF is usable are performed in advance in the procedure 3 according to the application example 1-1, and thus the procedure 6 and the procedure 7 according to the application example 1 are not performed.

(Procedures 7 to 9)

Thereafter, in procedures 7 to 9, the same processes as in the procedures 9 to 11 according to the application example 1 (FIG. 15) are performed. Accordingly, it is possible for the UE 1 to send data to the server 3.

### Application Example 2

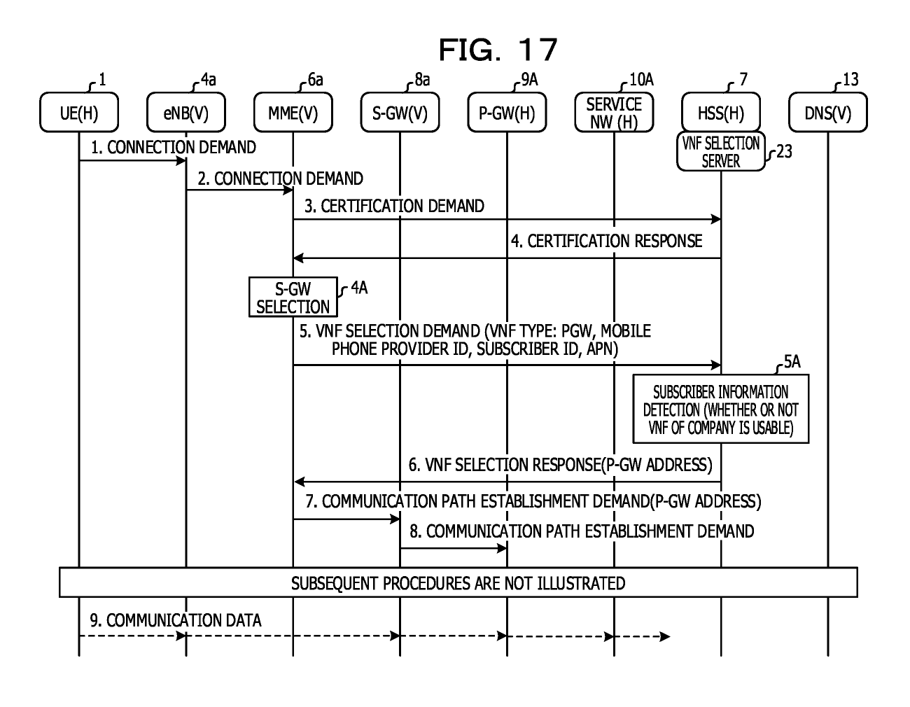

As an application example 2, a procedure, which is performed when roaming is performed in a pattern in which target VNFs which are deployed in the service area of the second carrier are the P-GW and the service network (refer to FIG. 5) and in which the VNF selection server 23 is shared with the HSS 7, will be described. FIG. 17 is a sequence diagram illustrating a roaming procedure according to the application example 2. The sharing means that a program, which causes the information processing apparatus 100 to operate as the VNF selection server 23, is mounted on the information processing apparatus 100, which operates as the HSS 7, and thus the information processing apparatus 100 operates as the HSS 7 and the VNF selection server 23.

(Procedures 1 to 4)

Since procedures 1 to 4 according to the application example 2 are the same as the procedures 1 to 4 according to the application example 1, the description thereof will not be repeated.

(Procedure 5)

When the certification is successful, the MME 6a performs an S-GW selection process using the existing method and sends a VNF selection demand to the HSS 7. The VNF selection demand includes the type of the VNF (P-GW), the first carrier ID, the subscriber ID, and the APN. The VNF selection demand is sent to the HSS 7. Therefore, unlike the application example 1, there is no procedure corresponding to the procedure 6 and the procedure 7 according to the application example 1.

(Procedure 5A and Procedure 6)

The HSS 7 (processor 101) searches for the subscriber information based on the subscriber ID and determines whether or not the VNF is usable for the subscriber (UE 1) (procedure 5A). When the VNF is usable, the HSS 7 (processor 101) operates as the VNF selection server 23, and searches for the first carrier ID and the P-GW address corresponding to the APN by referring to the preservation unit 232. The HSS 7 sends (supplies) the acquired P-GW address to the MME 6a (procedure 6).

(Procedures 7 to 9)

Since procedures 7 to 9 according to the application example 2 are the same as the procedures 9 to 11 according to the application example 1, the description thereof will not be repeated. In the application example 2, it is possible to perform setting such that the destination of the VNF selection server 23 is the same as the HSS 7, and thus it is possible to reduce the number of addresses to be managed. Since the HSS 7 is included in the first carrier network, management may be performed more easily compared to a case in which the VNF selection server 23 is deployed in the second carrier network or in the vicinity (remote place) thereof.

### Application Example 2-1

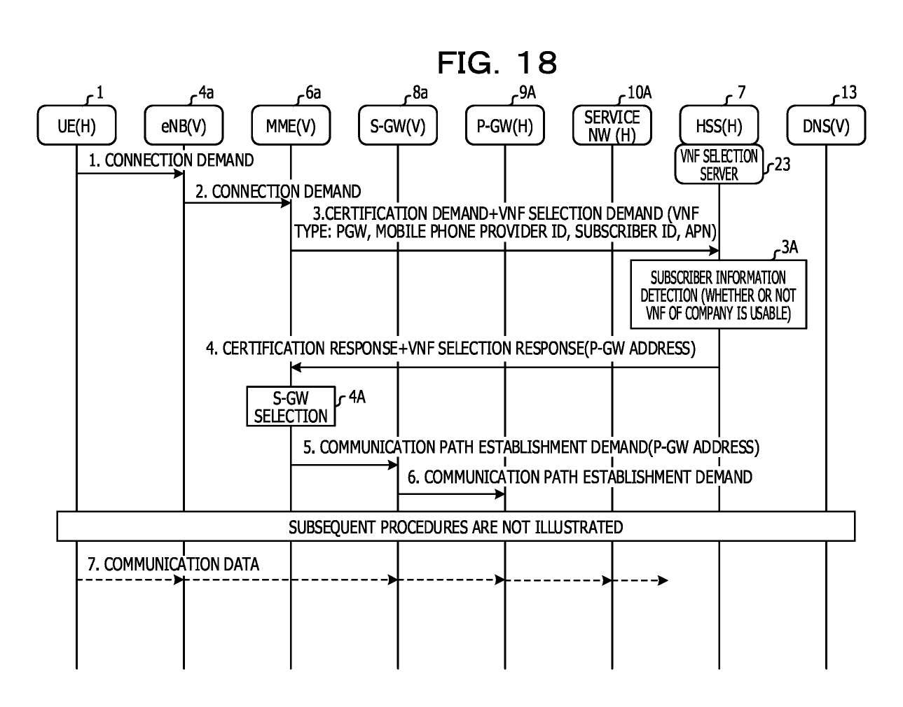

In the application example 2 (FIG. 17), the HSS 7 is accessed twice in the procedure 3 and the procedure 5. A modification example of the application example 2, in which the HSS 7 is accessed only once, will be described as an application example 2-1 with reference to FIG. 18.

(Procedures 1 to 3)

In FIG. 18, a procedure 1 and a procedure 2 are the same as in the application example 2 (FIG. 17), and thus the description thereof will not be repeated. The MME 6a sends a certification demand for the UE 1 and a VNF selection demand to the HSS 7 (procedure 3).

(Procedure 3A and Procedure 4)

The HSS 7 (processor 101), which receives the certification demand and the VNF selection demand, performs a process of certifying the UE 1. When the certifying process is successful, the HSS 7 determines whether or not the VNF is usable based on the subscriber ID (procedure 3A). When the VNF is usable, the HSS 7 (processor 101) operates as the VNF selection server 23, and searches for the first carrier ID and the P-GW address corresponding to the APN from the preservation unit 232. The HSS 7 (processor 101) sends (supplies) a response message which includes the P-GW address (certify response+VNF selection response) to the MME 6a (procedure 4).

(Procedure 4A and Procedures 5 to 7)

The MME 6a performs an S-GW selection process (procedure 4A). Since subsequent procedures 5 to 7 are the same as the procedures 9 to 11 according to the application example 1, the description thereof will not be repeated.

### Application Example 3

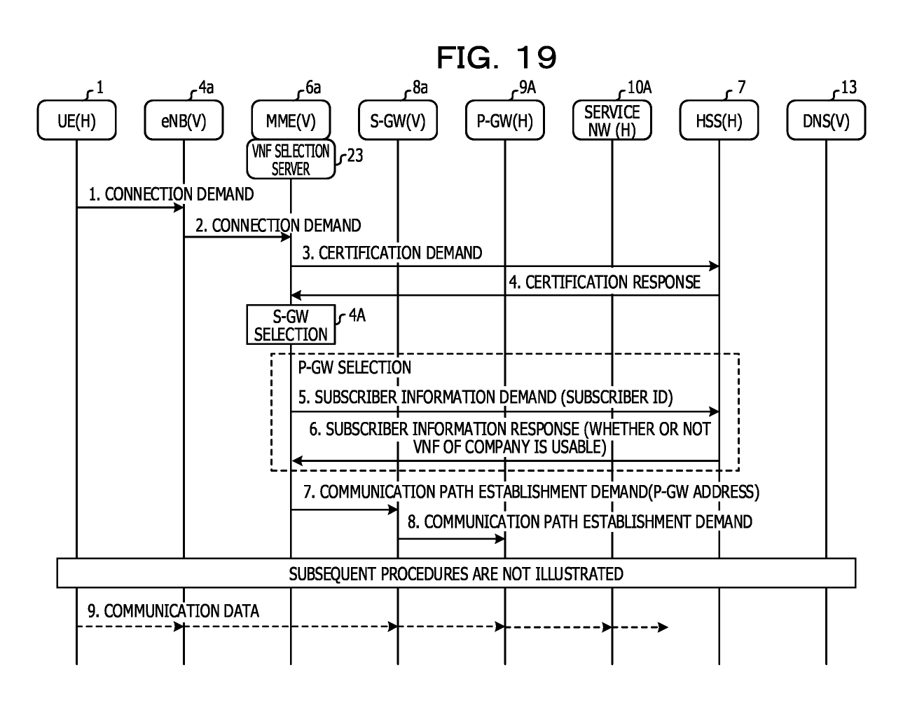

In an application example 3, a procedure, which is performed when roaming is performed in a pattern below, will be described. That is, target VNFs, which are deployed in the service area of the second carrier, are the P-GW and the service network (refer to FIG. 5). In addition, the VNF selection server 23 and the MME 6a are mounted on the same information processing apparatus 100. FIG. 19 is a sequence diagram illustrating a roaming procedure according to the application example 3.

(Procedures 1 to 4)

Since procedures 1 to 4 in FIG. 19 are the same as procedures 1 to 4 according to the application example 1 (FIG. 15), the description thereof will not be repeated.

(Procedures 4A, 5, and 6)

When the certification is successful, the MME 6a (processor 101) performs an S-GW selection process using an existing method (procedure 4A). Further, the MME 6a (processor 101) makes inquiries at the HSS 7 about the subscriber information demand, which includes the subscriber ID, in order to perform a P-GW selection process (procedure 5). The HSS 7 determines whether or not the VNF is usable for the UE 1 based on the subscriber ID, and sends the result of determination to the MME 6a as a subscriber information response (procedure 6).

(Procedure 7)

When the subscriber information response from the HSS 7 indicates that the VNF is usable, the MME 6a (the processor 101 of the information processing apparatus 100) executes the program of the VNF selection server 23. The processor 101 searches for the first carrier ID and the P-GW address corresponding to the APN from the preservation unit 232, and supplies the first carrier ID and the P-GW address corresponding to the APN to the program of the MME 6a in the information processing apparatus 100. If so, the MME 6a (processor 101) sends a communication path establishment demand to the S-GW which includes the S-GW address acquired in the S-GW selection process. The communication path establishment demand includes the P-GW address.

(Procedures 8 and 9)

Since procedures 8 and 9 are the same as the procedures 10 and 11 according to the application example 1, the description thereof will not be repeated.

In the application example 3, the information processing apparatus 100 operates as the MME 6a and the VNF selection server 23. Therefore, it is possible to save the labor taken when the MME 6a makes inquiries at another device about the S-GW and the P-GW.

As described above, in the application example 3, the first carrier ID, which is the search key, and the P-GW address, which is the result of the search, are transferred between the program (the routine or the process) of the MME 6a and the program (the routine or the process) of the VNF selection server 23. In other words, the found P-GW address is supplied to the MME 6a in the information processing apparatus 100.

As above, even when the MME 6a and the VNF selection server 23 are mounted on the information processing apparatus 100, the P-GW address (information indicative of the communication devices of the first carrier) corresponding to the search key is found and is supplied to a machine (MME 6a) which forms the communication path of the UE 1. This is applied to other application examples 3-1, 7, and 7-1 which will be described later.

### Application Example 3-1

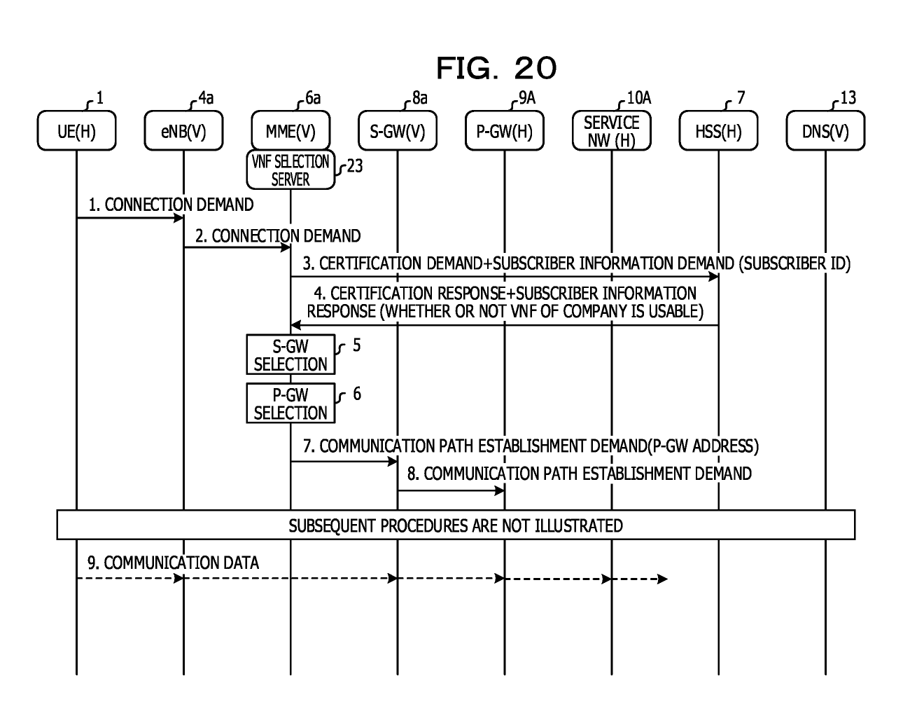

In the application example 3 (FIG. 19), the HSS 7 is accessed twice in the procedure 3 and the procedure 5. A modification example of the application example 3, in which the HSS 7 is accessed only once, will be described as an application example 3-1 with reference to FIG. 20.

(Procedures 1 to 4)

Since procedures 1 and 2 illustrated in FIG. 20 are the same as the procedures 1 and 2 according to the application example 3 (FIG. 19), the description thereof will not be repeated. Since procedures 3 and 4 are the same as the procedures 3 and 4 according to the application example 1-1 (FIG. 16), the description thereof will not be repeated.

(Procedures 5 and 6)

When the certification is successful, the MME 6a performs an S-GW selection process using the existing method (procedure 5). In addition, when the response from the HSS 7 indicates that the VNF is usable, the MME 6a operates as the VNF selection server 23 and performs a P-GW selection process (procedure 6). The MME 6a finds the first carrier ID and the P-GW address corresponding to the APN as the result of the P-GW selection process.

(Procedures 7 to 9)

The MME 6a sends a communication path establishment demand, which includes the P-GW address, to the S-GW which includes the S-GW address acquired in the S-GW selection process (procedure 7). Since procedures 8 and 9 are the same as the procedures 8 and 9 according to the application example 3, the description thereof will not be repeated.

### Application Example 4

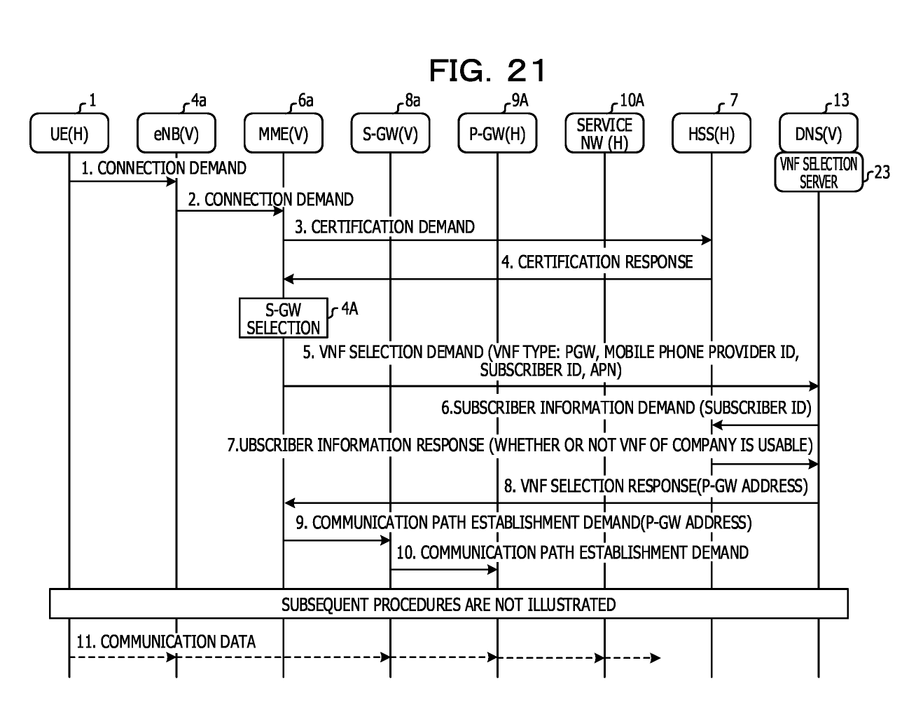

As an application example 4, a procedure, which is performed when roaming is performed in a pattern in which target VNFs which are deployed in the service area of the second carrier are the P-GW and the service network (refer to FIG. 5) and in which the VNF selection server 23 is shared with the DNS server 13 (mounted on the information processing apparatus 100), will be described. FIG. 21 is a sequence diagram illustrating a roaming procedure according to the application example 4.

(Procedures 1 to 4)

Since procedures 1 to 4 in FIG. 21 are the same as the procedures 1 to 4 according to the application example 1, the description thereof will not be repeated.

(Procedures 4A and 5)

When the certification is successful, the MME 6a performs the S-GW selection process using the existing method (procedure 4A). In addition, the MME 6a sends a VNF selection demand, which demands the P-GW address, to the DNS server 13. The VNF selection demand includes a first carrier ID, a subscriber ID, and an APN.

(Procedures 6 and 7)

The DNS server 13 (processor 101) makes inquiries at the HSS 7 about the subscriber information demand which includes the subscriber ID (procedure 6). The HSS 7 provides a response (subscriber information response), which indicates whether or not the VNF is usable and which is determined using the subscriber ID, to the DNS server 13 (procedure 7).

(Procedures 8 to 11)

When the response from the HSS 7 indicates that the VNF is usable, the DNS server 13 (processor 101) operates as the VNF selection server 23, and searches for the first carrier ID and the P-GW address corresponding to the APN from the preservation unit 232. The DNS server 13 sends (supplies) the P-GW address to the MME 6a (procedure 8). Since procedures 9 to 11 are the same as the procedures 9 to 11 according to the application example 1, the description thereof will not be repeated.

### Application Example 4-1

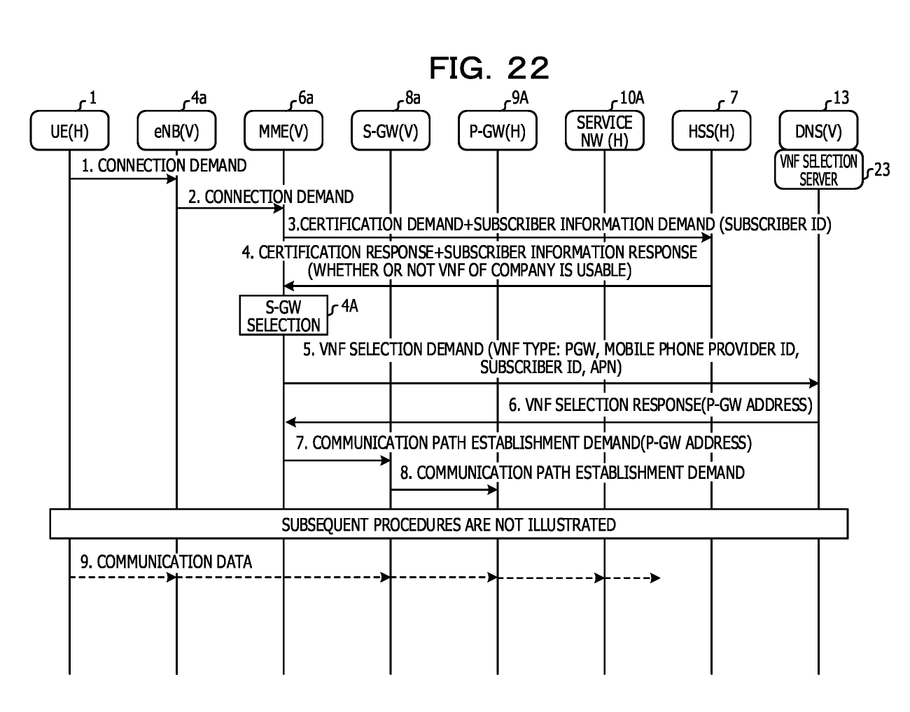

In the application example 4, the HSS 7 is accessed twice in the procedures 3 and 6. A modification example of the application example 4, in which the HSS 7 is accessed only once, will be described as an application example 4-1 with reference to FIG. 22.

(Procedures 1 to 4)

Since procedures 1 and 2 in FIG. 22 are the same as the procedures 1 and 2 according to the application example 1 (FIG. 15), the description thereof will not be repeated. In addition, since procedures 3 and 4 are the same as the procedures 3 and 4 according to the application example 1-1 (FIG. 16), the description thereof will not be repeated.

(Procedures 4A and 5)

When the results of the inquiries from the HSS 7 indicate that the VNF is usable, the MME 6a performs procedures 4A and 5 which are the same as the procedures 4A and 5 according to the application example 4.

(Procedures 6 to 9)

The DNS server 13 (processor 101) acquires the first carrier ID and the P-GW address corresponding to the APN from the preservation unit 232 based on the VNF selection demand, and transmits the first carrier ID and the P-GW address corresponding to the APN to the MME 6a (procedure 6). Since subsequent procedures 7 to 9 are the same as the procedures 9 to 11 according to application example 4, the description thereof will not be repeated.

### Application Example 5

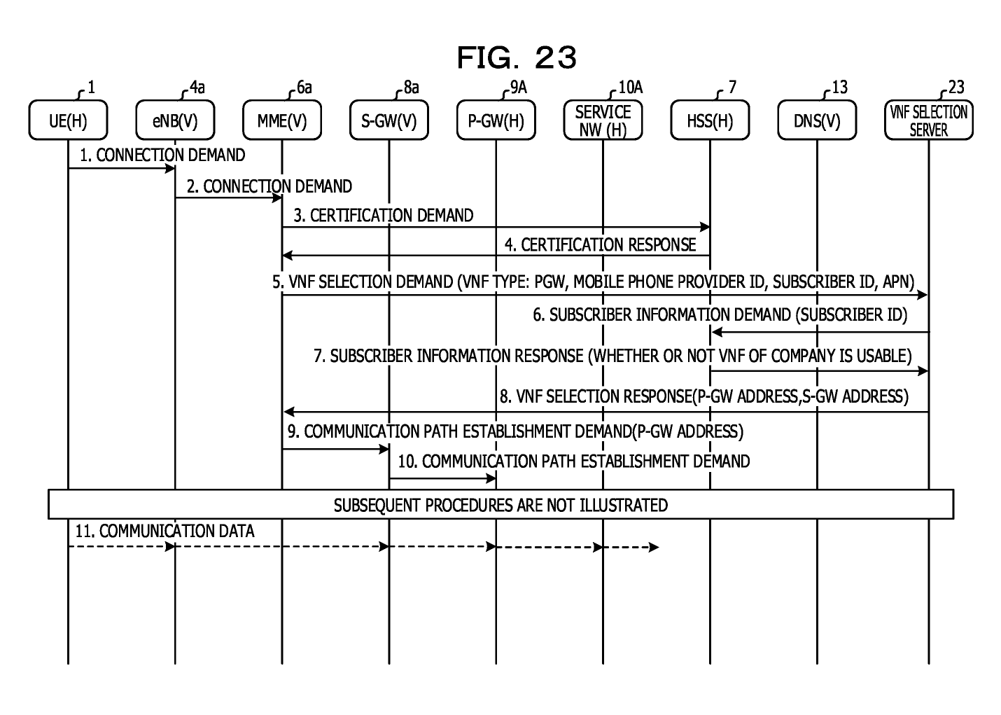

As an application example 5, an application example, in which the deployment target VNFs are the S-GW, the P-GW, and the service network (FIG. 6) and the VNF selection server is an independent machine (which is mounted on the information processing apparatus 100), will be described. FIG. 23 is a sequence diagram illustrating a roaming procedure according to an application example 5.

(Procedures 1 to 4)

Since procedures 1 to 4 in FIG. 23 are the same as the procedures 1 to 4 according to the application example 1, the description thereof will not be repeated.

(Procedure 5)

When the certification is successful, the MME 6a, which receives the result of the certification, sends a VNF selection demand message to the VNF selection server 23 in order to solve the IP addresses of the S-GW and the P-GW of the first carrier. The VNF selection demand includes a fact that the types of the selection target VNFs are the S-GW and the P-GW, the first carrier ID, the subscriber ID, and the APN. In addition, it is considered that the VNF selection demand includes the TAC in order to select the S-GW of the first carrier.

(Procedures 6 and 7)

Since procedures 6 and 7 are the same as the procedures 6 and 7 according to the application example 1, the description thereof will not be repeated.

(Procedure 8)

When the VNFs are usable as the results of the inquiries at the HSS 7, the VNF selection server 23 (processor 101), which receives the response from the HSS 7, refers to the preservation unit 232 (database 232B (FIG. 12)) based on the types of the selection target VNFs included in the inquiries. The VNF selection server 23 (processor 101) reads the first carrier ID, which is included in the inquiries, and the IP address of the P-GW (P-GW address) corresponding to the APN from the database 232B. In addition, the VNF selection server 23 (processor 101) reads the IP address of the S-GW (S-GW address) corresponding to the first carrier ID, which is included in the inquiries, from the database 232C (FIG. 13). Further, the VNF selection server 23 (processor 101) sends the S-GW address and the P-GW address to the MME 6a.

(Procedure 9)

The MME 6a, which receives the S-GW address and the P-GW address, sends a communication path establishment demand message to the S-GW 8A which includes the received S-GW address. The communication path establishment demand includes the received P-GW address.

(Procedures 10 and 11)

Since subsequent procedures 10 and 11 are the same as the procedures 10 and 11 according to the application example 1, the description thereof will not be repeated.

### Application Example 5-1

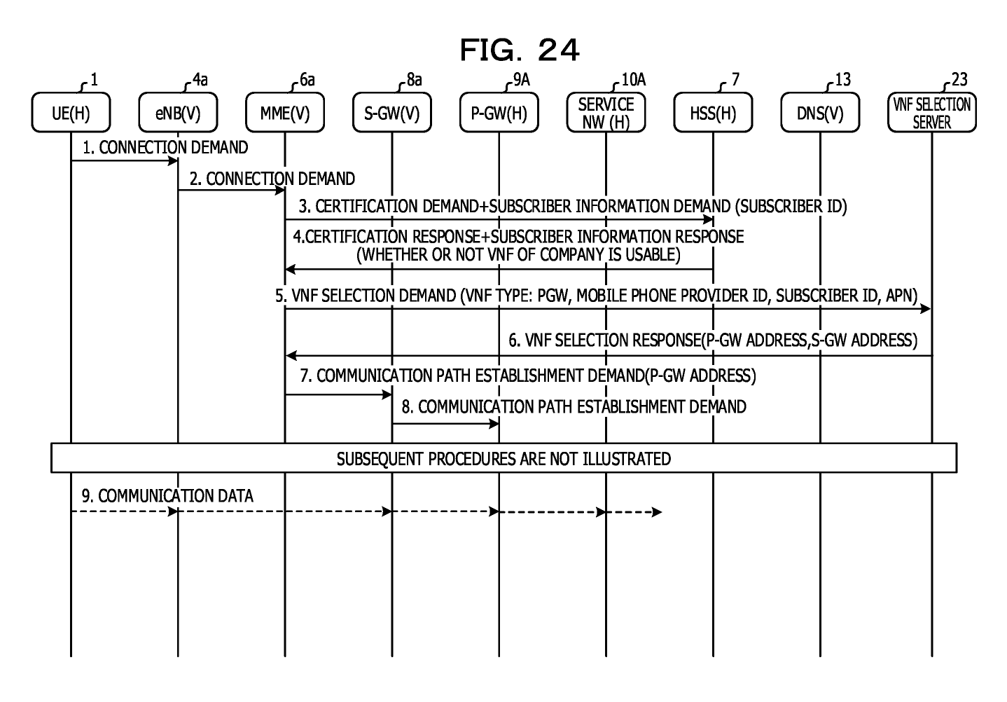

In the application example 5 (FIG. 23), the HSS 7 is accessed twice in the procedures 3 and 6. A modification example of the application example 5, in which the HSS 7 is accessed only once, will be described as an application example 5-1 with reference to FIG. 24.

(Procedures 1 to 4)

Since procedures 1 and 2 illustrated in FIG. 24 are the same as in the application example 5 (FIG. 23), the description thereof will not be repeated. Since procedures 3 and 4 are the same as the procedures 3 and 4 according to the application example 1-1 (FIG. 16), the description thereof will not be repeated.

(Procedure 5)

When the VNFs are usable as the results of the inquiries at the HSS 7, the MME 6a sends a VNF selection demand, which is sent in the procedure 5 of FIG. 23, to the VNF selection server 23.

(Procedure 6)

The VNF selection server 23 (processor 101) acquires the first carrier ID and the P-GW address corresponding to the APN with regard to the VNF at which the inquiries are made by referring to the preservation unit 232, and acquires the S-GW address corresponding to the first carrier ID. The VNF selection server 23 (processor 101) sends the S-GW address and the P-GW address to the MME 6a. As above, in the application example 5-1, inquiries about whether or not the VNFs are usable are made in advance in the procedure 3, and thus processes in procedures 6 and 7 according to the application example 5 are not performed.

(Procedures 7 to 9)

Thereafter, the same processes as in the procedures 9 to 11 according to the application example 5 (FIG. 23) are performed as procedures 7 to 9. Accordingly, it is possible for the UE 1 to send data to the server 3.

### Application Example 5-2

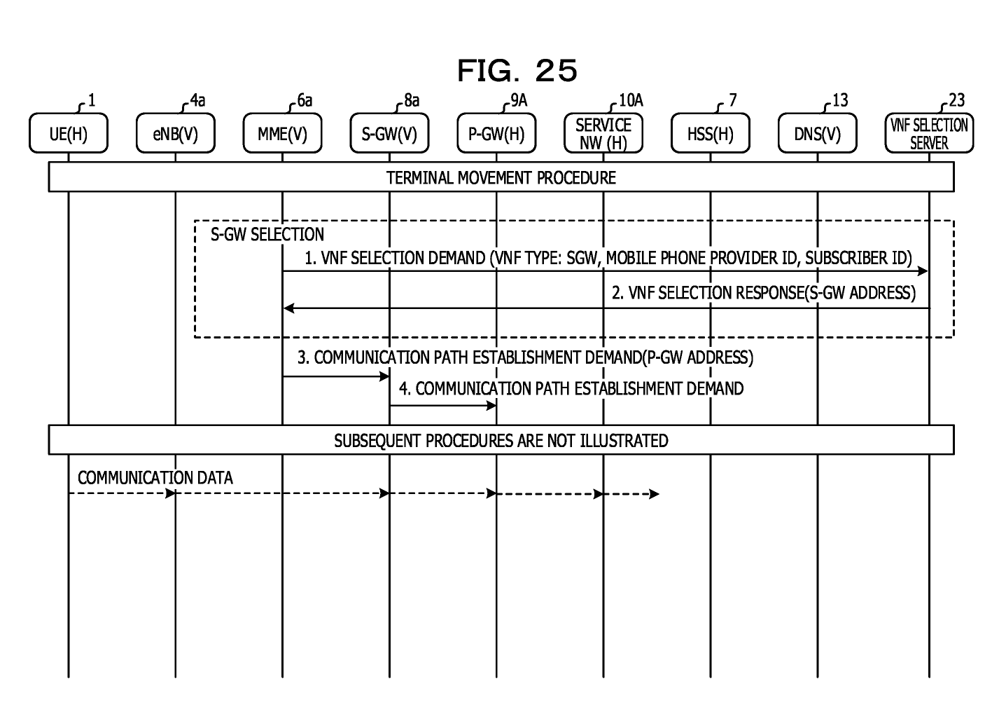

A procedure, performed when the UE 1 which starts the data communication in the procedures according to the application example 5 and the application example 5-1 moves (hands over) in the second carrier network, will be described with reference to a sequence diagram of FIG. 25.

(Procedure 1)

When a procedure (handover procedure), in which the UE 1 moves, is performed, the MME 6a sends a VNF selection demand to the VNF selection server 23 in order to determine whether or not the S-GW 8A has to be switched in accordance with the movement of the UE 1. The VNF selection demand includes the type of the VNF (S-GW), a first carrier ID, and a subscriber ID. In addition, it is considered that the VNF selection demand includes the TAC.

(Procedure 2)

The VNF selection server 23 (processor 101), which receives the VNF selection demand, reads an S-GW address corresponding to the first carrier ID included in the VNF selection demand from the preservation unit 232. At this time, it is considered that the selection is performed based on the TAC. Further, the VNF selection server 23 sends the S-GW address to the MME 6a.

(Procedure 3)

When the received S-GW address is changed from the previous S-GW address, the MME 6a determines that the S-GW has to be switched. In this case, the MME 6a sends a communication path establishment demand to the S-GW (S-GW 8B) which includes the S-GW address acquired in the procedure 2. The establishment demand includes the P-GW address of the P-GW 9A.

(Procedure 4)

The S-GW 8B sends a communication path change demand to the P-GW 9A which includes the P-GW address acquired in the procedure 3. Thereafter, a process of changing a data communication path is performed, and, finally, it is possible for the UE 1 to communicate with the server 3 through the data communication path which passes through a new (handover destination) base station 4a and the S-GW 8B.

### Application Example 6

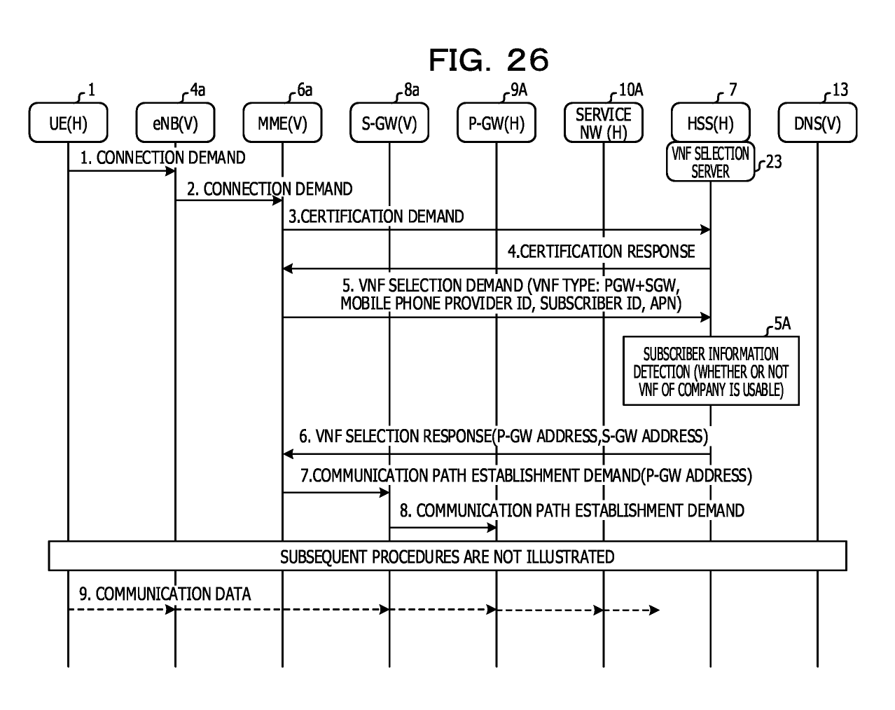

As an application example 6, an application example of a case in which the deployment target VNFs are the S-GW, the P-GW, and the service network (FIG. 6) and in which the VNF selection server 23 is shared with the HSS 7 will be described. FIG. 26 is a sequence diagram illustrating a roaming procedure according to the application example 6.

(Procedures 1 to 4)

Since procedures 1 to 4 in FIG. 26 are the same as the procedures 1 to 4 according to the application example 1, the description thereof will not be repeated.

(Procedure 5)

When the certification is successful, the MME 6a performs an S-GW selection process using the existing method and sends a VNF selection demand to the HSS 7. The VNF selection demand includes the types of the VNFs (the S-GW and the P-GW), a first carrier ID, a subscriber ID, and an APN. In addition, it is considered that the TAC is included in order to select the S-GW.

(Procedures 5A and 6)

The HSS 7 (processor 101) searches for subscriber information based on the subscriber ID and determines whether or not the VNFs are usable for the subscriber (UE 1) (procedure 5A). When the VNFs are usable, the HSS 7 (processor 101) operates as the VNF selection server 23, and searches for the first carrier ID, the P-GW address corresponding to the APN, and the S-GW address corresponding to the first carrier ID by referring to the preservation unit 232. The TAC may be used to select the S-GW address. The HSS 7 sends the acquired S-GW address and the P-GW address to the MME 6a (procedure 6).

(Procedures 7 to 9)

Since procedures 7 to 9 according to the application example 6 are the same as the procedures 9 to 11 according to the application example 1, the description thereof will not be repeated. In the application example 6, it is possible to acquire advantages which are similar to the advantages which are described with regard to the application example 2.

### Application Example 6-1

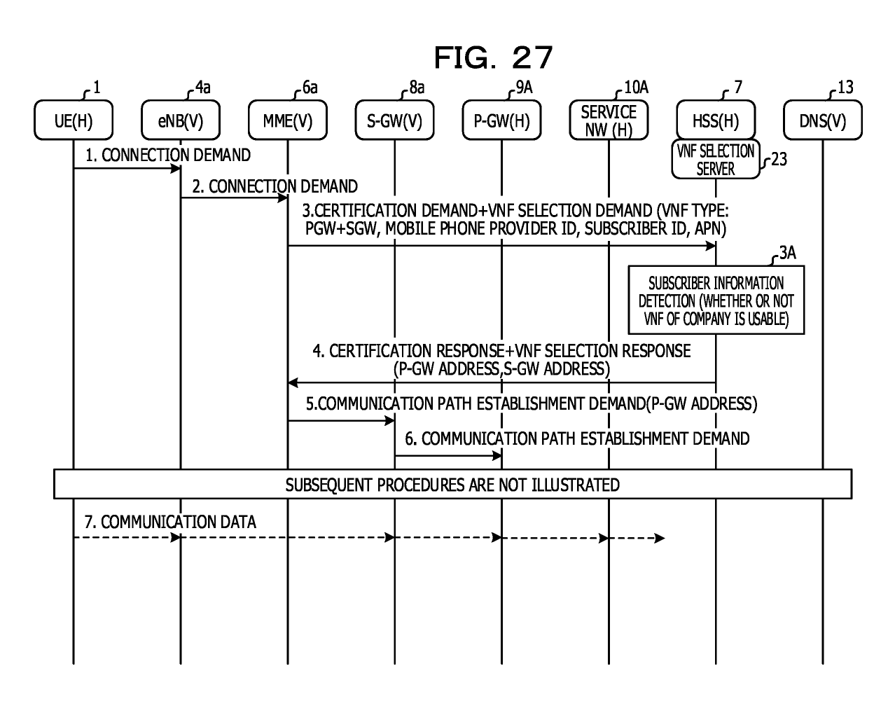

In the application example 6 (FIG. 26), the HSS 7 is accessed twice in the procedures 3 and 5. A modification example of the application example 6, in which the HSS 7 is accessed only once, will be described as an application example 6-1 with reference to FIG. 27.

(Procedures 1 to 3)

Since procedures 1 and 2 illustrated in FIG. 27 are the same as the in the application example 6 (FIG. 26), the description thereof will not be repeated. The MME 6a sends a VNF selection demand and a demand of certification of the UE 1 to the HSS 7 (procedure 3).

(Procedures 3A and 4)

The HSS 7 (processor 101), which receives the certification demand and the VNF selection demand, performs a process of certifying the UE 1. When the certifying process is successful, the HSS 7 determines whether or not the VNF is usable based on the subscriber ID (procedure 3A). When the VNF is usable, the HSS 7 (processor 101) operates as the VNF selection server 23, and acquires the first carrier ID, the P-GW address corresponding to the APN, and the S-GW address corresponding to the first carrier ID from the preservation unit 232. The HSS 7 (processor 101) sends (supplies) a response message which includes the S-GW address and the P-GW address (certify response+VNF selection response) to the MME 6a (procedure 4).

(Procedures 5 to 7)

Since processes performed in procedures 5 to 7 are the same as, for example, the processes performed in the procedures 9 to 11 according to the application example 6, the description thereof will not be repeated.

### Application Example 6-2

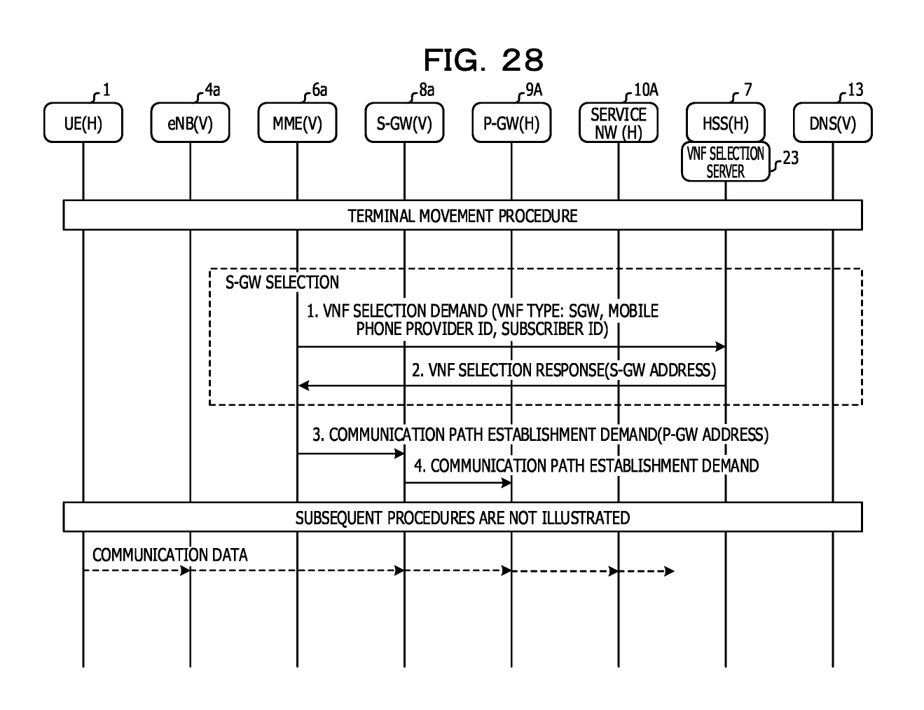

A procedure performed when the UE 1, which starts data communication using the procedures according to the application example 6 and the application example 6-1, moves (hands over) in the second carrier network will be described using a sequence diagram of FIG. 28.

(Procedure 1)

When the procedure (handover procedure), in which the UE 1 moves, is performed, the MME 6a sends a VNF selection demand to the HSS 7 in order to determine whether or not the S-GW 8A has to be switched in accordance with the movement of the UE 1. The VNF selection demand includes the type of the VNF (S-GW), a first carrier ID, and a subscriber ID. In addition, it is considered that the VNF selection demand includes the TAC.

(Procedure 2)

The HSS 7 (processor 101), which receives the VNF selection demand, operates as the VNF selection server 23, and reads an S-GW address corresponding to the first carrier ID, which is included in the VNF selection demand, from the preservation unit 232. At this time, it is considered that the S-GW address is selected based on the TAC. Further, the HSS 7 sends the S-GW address to the MME 6a.

(Procedure 3)

When the received S-GW address is changed from the previous S-GW address, the MME 6a determines that the S-GW has to be switched. In this case, the MME 6a sends a communication path establishment demand to the S-GW (S-GW 8B) which includes the S-GW address acquired in the procedure 2. The establishment demand includes the P-GW address of the P-GW 9A.

(Procedure 4)

The S-GW 8B sends a communication path change demand to the P-GW 9A which includes the P-GW address acquired in the procedure 3. Thereafter, a process of changing the data communication path is performed, and, finally, it is possible for the UE 1 to communicate with the server 3 through a data communication path which passes through the new base station 4a (handover destination) and the S-GW 8B.

### Application Example 7

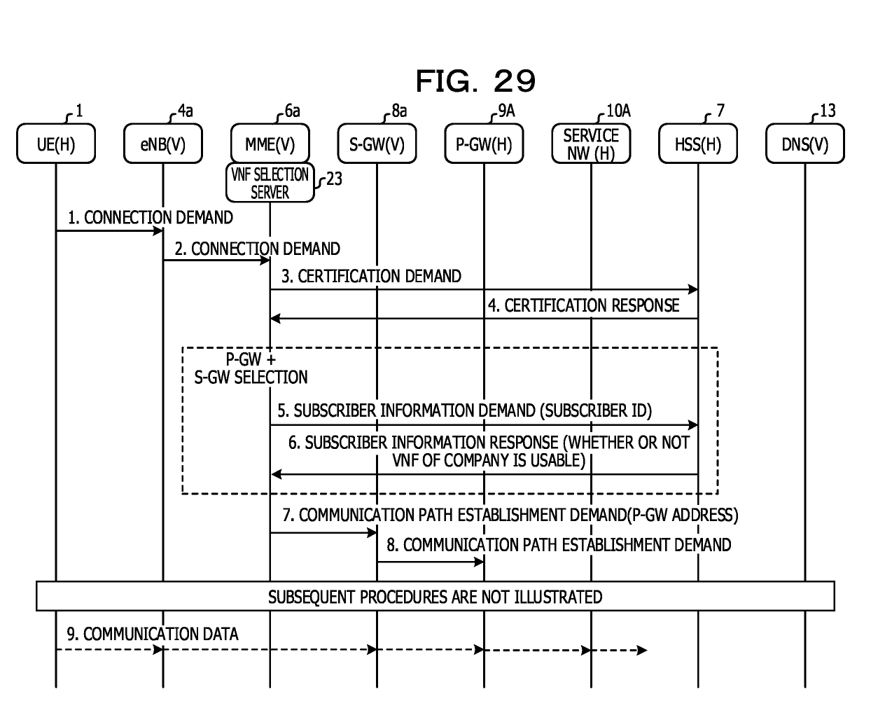

As an application example 7, a procedure, which is performed when roaming is performed in a pattern in which target VNFs which are deployed in the service area of the second carrier are the S-GW, the P-GW and the service network (FIG. 6) and in which the VNF selection server 23 is shared with the MME 6a (mounted on the same information processing apparatus 100), will be described. FIG. 29 is a sequence diagram illustrating a roaming procedure according to the application example 7.

(Procedures 1 to 4)

Since procedures 1 to 4 in FIG. 29 are the same as the procedures 1 to 4 according to the application example 1 (FIG. 15), the description thereof will not be repeated.

(Procedures 5 and 6)

When the certification is successful, the MME 6a (processor 101) makes inquiries at the HSS 7 about a subscriber information demand, which includes a subscriber ID, in order to perform a process of selecting the S-GW and the P-GW (procedure 5). The HSS 7 determines whether or not the VNFs are usable for the UE 1 based on the subscriber ID, and sends the result of determination to the MME 6a as a subscriber information response (Procedure 6).

(Procedure 7)

When the subscriber information response, which is received from the HSS 7, indicates that the VNFs are usable, the MME 6a (processor 101) operates as the VNF selection server 23, and searches for a first carrier ID and a P-GW address corresponding to an APN from the preservation unit 232. In addition, the MME 6a searches for an S-GW address corresponding to the first carrier ID. A case in which the S-GW address is searched for based on the TAC is considered. The TAC is used in the same manner in application examples below (point by point description will not be repeated). Further, the MME 6a (processor 101) sends a communication path establishment demand to the S-GW which includes the S-GW address acquired from the preservation unit 232. The communication path establishment demand includes the P-GW address.

(Procedures 8 and 9)

Since procedures 8 and 9 are the same as the procedures 10 and 11 according to the application example 1, the description thereof will not be repeated. In the application example 7, it is possible to acquire the same advantages as in the application example 3.

### Application Example 7-1

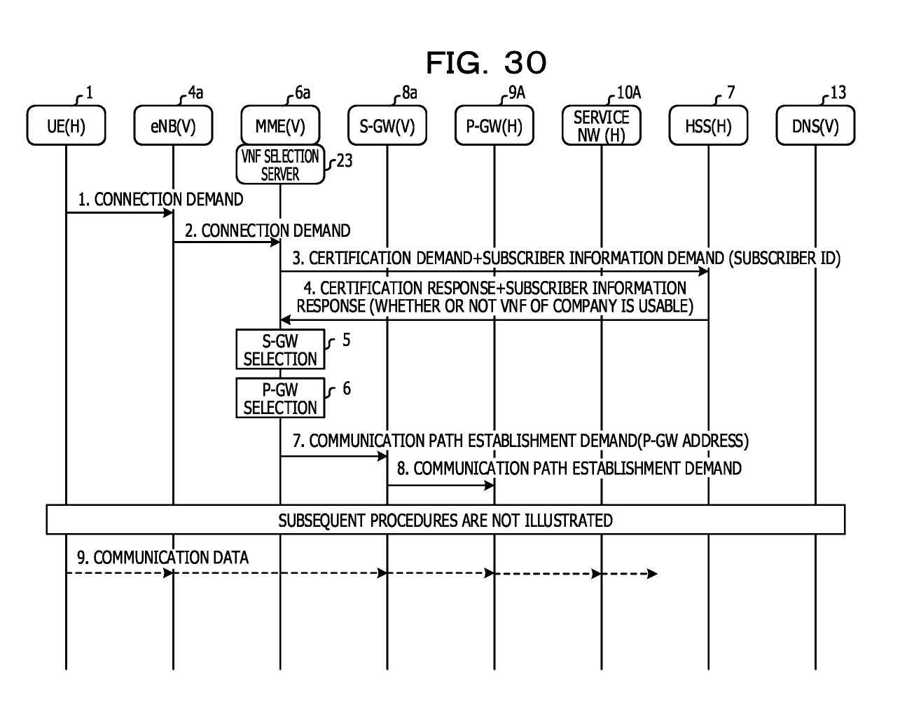

In the application example 7 (FIG. 29), the HSS 7 is accessed twice in the procedures 3 and 5. A modification example of the application example 7, in which the HSS 7 is accessed only once, will be described as an application example 7-1 with reference to FIG. 30.

(Procedures 1 to 4)

Since procedures 1 and 2 illustrated in FIG. 30 are the same as the procedures 1 and 2 according to the application example 7 (FIG. 29), the description thereof will not be repeated. Since procedures 3 and 4 are the same as the procedures 3 and 4 according to the application example 1-1 (FIG. 16), the description thereof will not be repeated.

(Procedures 5 and 6)

When a response from the HSS 7 indicates that the certification is successful and the VNFs are permitted to be used, the MME 6a operates as the VNF selection server 23, and searches for an S-GW address corresponding to the first carrier ID from the preservation unit 232 (procedure 5). In addition, the MME 6a operates as the VNF selection server 23, and searches for the first carrier ID and the P-GW address corresponding to the APN from the preservation unit 232 (procedure 6).

(Procedures 7 to 9)

Since procedures 7 to 9 are the same as the procedures 7 to 9 according to the application example 7 (FIG. 29), the description thereof will not be repeated.

### Application Example 7-2

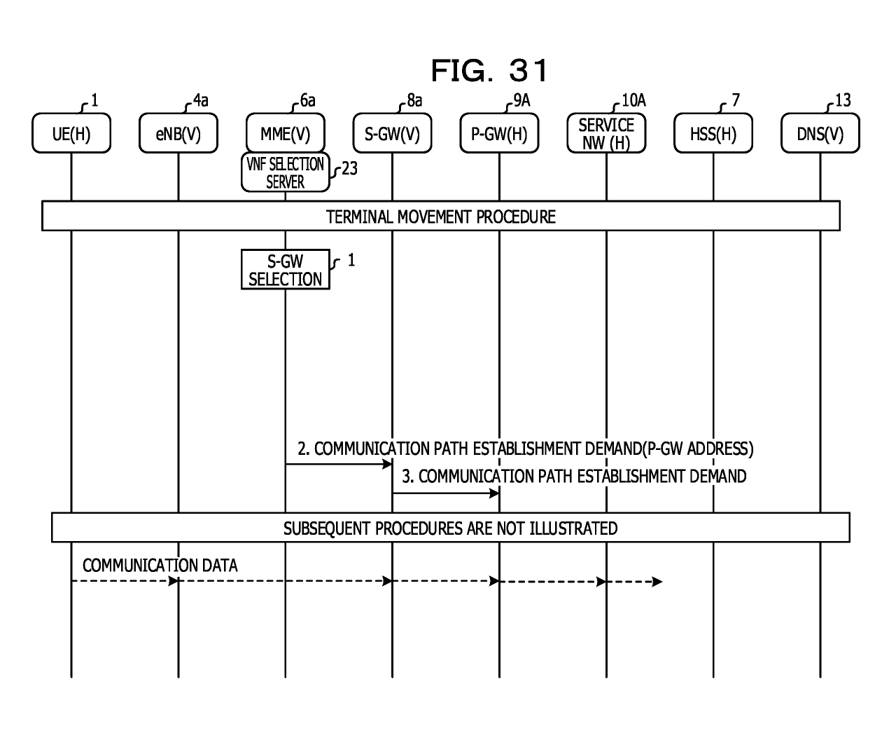

A procedure, which is performed when the UE 1 which starts the data communication using the procedures according to the application example 7 and the application example 7-1 moves (hands over) in the second carrier network, will be described with reference to a sequence diagram of FIG. 31.

(Procedure 1)

When the procedure (handover procedure), in which the UE 1 moves, is performed, the MME 6a operates as the VNF selection server 23 in order to determine whether or not the S-GW 8A has to be switched in accordance with the movement of the UE 1, and reads the S-GW address corresponding to a first carrier ID from the preservation unit 232. When the read S-GW address is changed from the previous S-GW address, the MME 6a determines that the S-GW has to be switched.

(Procedure 2)

In this case, the MME 6a sends a communication path establishment demand to the S-GW (S-GW 8B) which includes the S-GW address acquired in the procedure 1. The establishment demand includes the P-GW address of the P-GW 9A.

(Procedure 3)

The S-GW 8B sends a communication path change demand to the P-GW 9A which includes the P-GW address acquired in the procedure 3. Thereafter, a process of changing the data communication path is performed, and thus, finally, it is possible for the UE 1 to communicate with the server 3 through a data communication path which passes through the new base station 4a (handover destination) and the S-GW 8B.

### Application Example 8

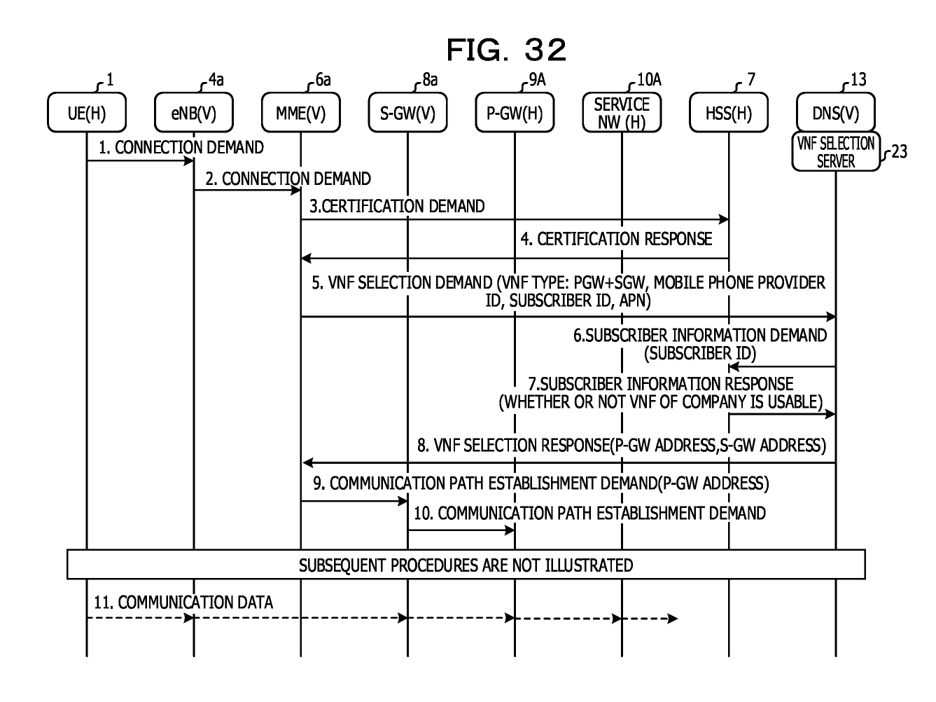

As an application example 8, a procedure, which is performed when roaming is performed in a pattern in which the deployment target VNFs are the S-GW, the P-GW and the service network (FIG. 6) and in which the VNF selection server 23 is shared with the DNS server 13 (mounted on the same information processing apparatus 100), will be described. FIG. 32 is a sequence diagram illustrating a roaming procedure according to the application example 8.

(Procedures 1 to 4)

Since procedures 1 to 4 in FIG. 32 are the same as the procedures 1 to 4 according to the application example 1, the description thereof will not be repeated.

(Procedure 5)

When the certification is successful, the MME 6a sends a VNF selection demand, which demands an S-GW address and a P-GW address, to the DNS server 13. The VNF selection demand includes the types of the VNFs (the S-GW and the P-GW), the first carrier ID, a subscriber ID, and an APN.

(Procedures 6 and 7)

DNS server 13 (processor 101) makes inquiries at the HSS 7 about a subscriber information demand, which includes the subscriber ID (procedure 6). The HSS 7 provides a response (subscriber information response), which indicates whether or not the VNFs are usable and which is determined using the subscriber ID, to the DNS server 13 (procedure 7).

(Procedures 8 to 11)

When the response from the HSS 7 indicates that the VNF is usable, the DNS server 13 (processor 101) operates as the VNF selection server 23. At this time, the DNS server 13 (processor 101) searches for the S-GW address corresponding to the first carrier ID from the preservation unit 232. In addition, the DNS server 13 searches for the first carrier ID and the P-GW address corresponding to the APN from the preservation unit 232. The DNS server 13 sends the S-GW address and the P-GW address to the MME 6a (procedure 8). Since procedures 9 to 11 are the same as the procedures 9 to 11 according to the application example 1, the description thereof will not be repeated.

### Application Example 8-1

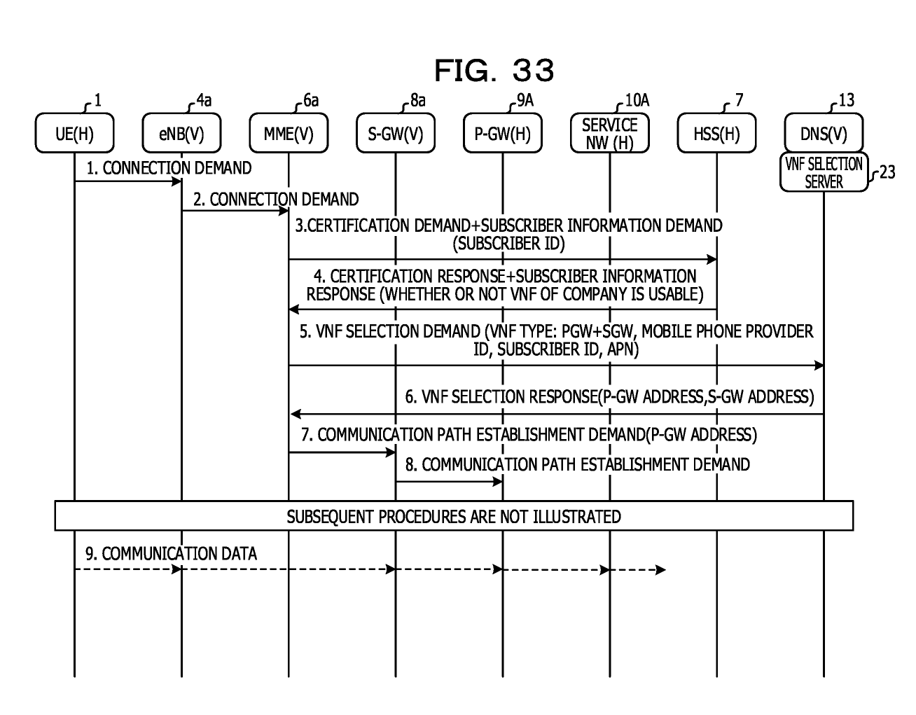

In the application example 8, the HSS 7 is accessed twice in the procedures 3 and 6. A modification example of the application example 8, in which the HSS 7 is accessed only once, will be described as an application example 8-1 with reference to FIG. 33.

(Procedures 1 to 4)

Since procedures 1 and 2 in FIG. 33 are the same as the procedures 1 and 2 according to the application example 1 (FIG. 15), the description thereof will not be repeated. In addition, since procedures 3 and 4 are the same as the procedures 3 and 4 according to the application example 1-1 (FIG. 16), the description thereof will not be repeated.

(Procedure 5)

When the results of the inquiries from the HSS 7 indicate that the VNF is usable, the MME 6a performs a procedure 5 which is the same as the procedure 5 according to the application example 8.

(Procedures 6 to 9)

The DNS server 13 (processor 101) acquires the S-GW address corresponding to the first carrier ID and the P-GW address corresponding to the first carrier ID and the APN from the preservation unit 232 based on the VNF selection demand, and sends the acquired S-GW address and the P-GW address to the MME 6a (procedure 6). Since subsequent procedures 7 to 9 are the same as the procedures 9 to 11 according to the application example 8, the description thereof will not be repeated.

### Application Example 8-2

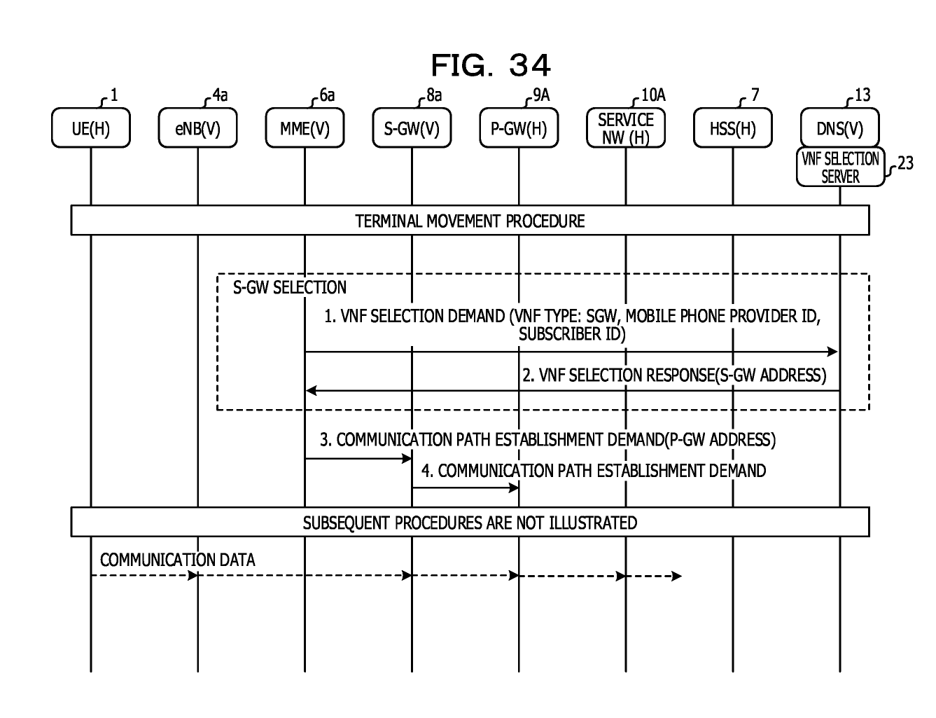

A procedure, performed when the UE 1 which starts the data communication in the procedures according to the application example 8 and the application example 8-1 moves (hands over) in the second carrier network, will be described with reference to a sequence diagram of FIG. 34.

(Procedure 1)

When the procedure (handover procedure), in which the UE 1 moves, is performed, the MME 6a sends a VNF selection demand to the DNS server 13 in order to determine whether or not the S-GW 8A has to be switched in accordance with the movement of the UE 1. The VNF selection demand includes the type of the VNF (S-GW), a first carrier ID, and a subscriber ID.

(Procedure 2)

The DNS server 13 (processor 101), which receives the VNF selection demand, operates as the VNF selection server 23, and reads an S-GW address corresponding to the first carrier ID included in the VNF selection demand from the preservation unit 232. Further, the DNS server 13 sends the S-GW address to the MME 6a.

(Procedure 3)

When the read S-GW address is changed from the previous S-GW address, the MME 6a determines that the S-GW has to be switched. In this case, the MME 6a sends a communication path establishment demand to the S-GW (S-GW 8B) which includes the S-GW address acquired in the procedure 2. The establishment demand includes the P-GW address of the P-GW 9A.

(Procedure 4)

The S-GW 8B sends a communication path change demand to the P-GW 9A which includes the P-GW address acquired in the procedure 3. Thereafter, a process of changing the data communication path is performed, and thus, finally, it is possible for the UE 1 to communicate with the server 3 through a data communication path which passes through the new base station 4a (handover destination) and the S-GW 8B.

### Application Example 9

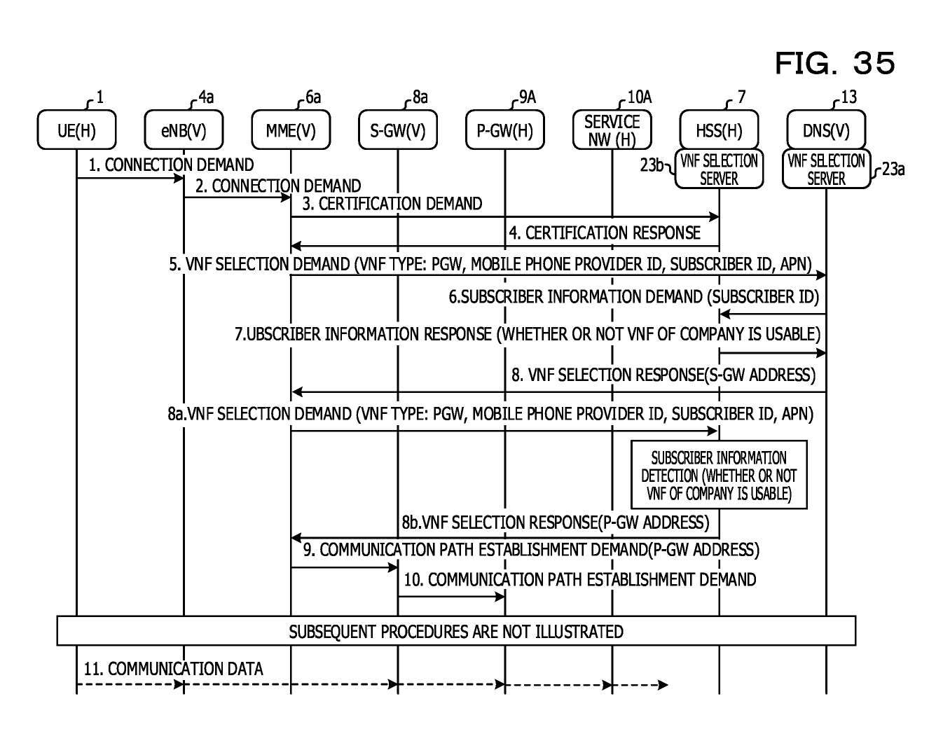

As an application example 9, a roaming procedure according to forms below will be described. The deployment target VNFs are the S-GW, the P-GW, and the service network (FIG. 6). In addition, a VNF selection server 23a for selecting the S-GW and a VNF selection server 23b for selecting the P-GW are prepared as the VNF selection server 23. The VNF selection server 23a is mounted on the information processing apparatus 100 which operates as the DNS server 13. In addition, the VNF selection server 23b is mounted on the information processing apparatus 100 which operates as the HSS 7. FIG. 35 is a sequence diagram illustrating the roaming procedure according to the application example 9.

(Procedures 1 to 4)

Since procedures 1 to 4 according to the application example 9 in FIG. 35 are the same as the procedures 1 to 4 according to the application example 1 (FIG. 15), the description thereof will not be repeated.

(Procedure 5)

When the certification is successful, the MME 6a sends a VNF selection demand to the DNS server 13 in order to solve an S-GW address. The VNF selection demand includes the type of the VNF (S-GW), a first carrier ID, and a subscriber ID.

(Procedures 6 and 7)

Since procedures 6 and 7 according to the application example 9 are the same as the procedures 6 and 7 according to the application example 1 (FIG. 15), the description thereof will not be repeated.

(Procedure 8)

When the results of the inquiries made at the HSS 7 indicate that the VNF is usable, the DNS server 13 (processor 101) operates as the VNF selection server 23b, searches the database 232C of the preservation unit 232, and reads the S-GW address corresponding to the first carrier ID. The DNS server 13 sends the found S-GW address to the MME 6a.

(Procedure 8a)

The MME 6a, which receives the S-GW address, sends the VNF selection demand to the HSS 7 in order to solve a P-GW address. The VNF selection demand includes the type of the VNF (P-GW), the first carrier ID, the subscriber ID, and an APN.

(Procedure 8b)

The HSS 7 (processor 101) searches for subscriber information based on the subscriber ID and determines whether or not the VNF is usable for the subscriber (UE 1) (procedure 5A). When the VNF is usable, the HSS 7 (processor 101) operates as the VNF selection server 23, and searches for the first carrier ID and the P-GW address corresponding to the APN by referring to the database 232B of the preservation unit 232. The HSS 7 sends the acquired P-GW address to the MME 6a.

(Procedure 9)

The MME 6a, which receives the P-GW address, sends a communication path establishment demand message to the S-GW 8A which includes the S-GW address which is received from the DNS server 13 (VNF selection server 23a). The communication path establishment demand includes the P-GW address.

(Procedure 10)

The S-GW 8A, which receives the communication path establishment demand, sends a communication path establishment demand message to the P-GW 9A which includes the P-GW address. Thereafter, a communication path is established between the P-GW 9A and the service network 10A which is the connection destination of the UE 1 and which is designated using the APN. Further, a wireless path is established between the base station 4a and the UE 1.

Since a subsequent procedure (call establishment procedure) is the same as in the application example 1, the description thereof will not be repeated. Finally, it is possible for the UE 1 to send data to the server 3 using the established data communication path (procedure 11).

### Application Example 9-1

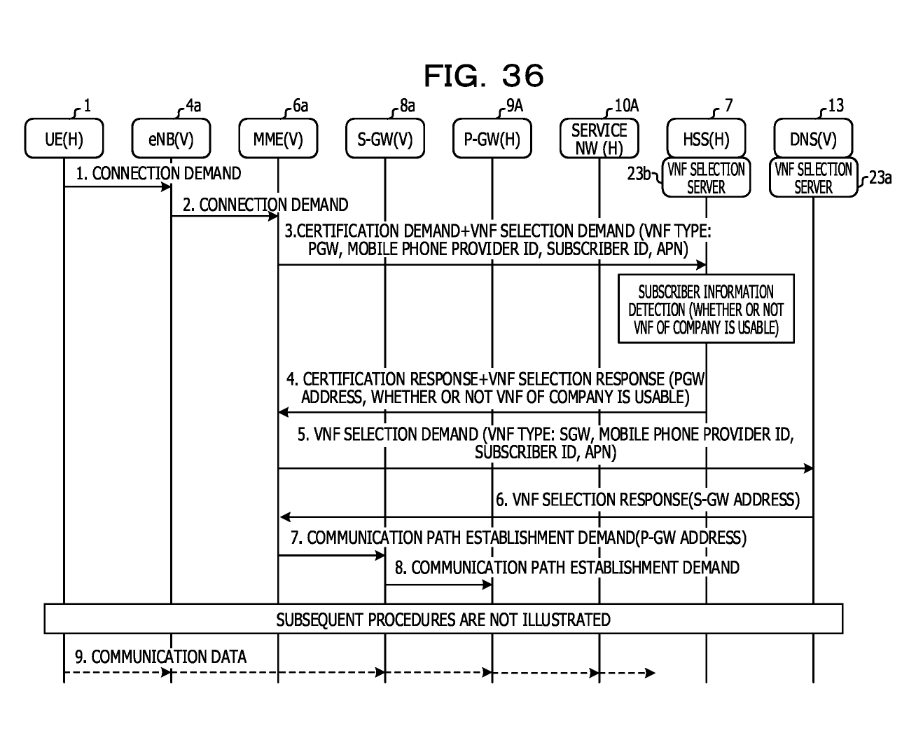

In the application example 9, the HSS 7 is accessed twice in the procedures 3 and 6. A modification example of the application example 9, in which the HSS 7 is accessed only once, will be described as an application example 9-1 with reference to FIG. 36.

(Procedures 1 to 4)

Procedures 1 and 2 according to the application example 9-1 are the same as the procedures 1 and 2 (FIG. 15) according to the application example 1. In addition, procedures 3 and 4 according to the application example 9-1 are the same as the procedures 3 and 4 according to the application example 2. Therefore, the description of the procedures 1 to 4 will not be repeated.

(Procedure 5)

The MME 6a receives the P-GW address and a result of whether or not the P-GW address is usable as the results of the inquiries made at the HSS 7. When the use of the VNF is permitted, the MME 6a sends a VNF selection demand to the DNS server 13 (VNF selection server 23a) in order to solve an S-GW address. The VNF selection demand includes the type of the VNF (S-GW), a first carrier ID, and a subscriber ID.

(Procedure 6)

The DNS server 13 operates as the VNF selection server 23a, reads the S-GW address corresponding to the first carrier from the preservation unit 232 (database 232C), and sends the S-GW address to the MME 6a.

(Procedures 7 to 9)

The MME 6a, which receives the S-GW address, sends a communication path establishment demand message to the S-GW 8A which includes the S-GW address. The communication path establishment demand includes a P-GW address. Since subsequent procedures 8 and 9 are the same as in the application example 9, the description thereof will not be repeated.

Meanwhile, in addition to the above-described application example 9, there is a combination in which the VNF selection server 23a and the VNF selection server 23b are distributedly deployed to the HSS 7, the DNS server 13, and the MME 6a. However, the details thereof will not be described.

### Advantages of Embodiment

According to the embodiment, when the UE 1 performs roaming in the second carrier network, it is possible to form the data communication path of the UE 1, which reaches the Internet 2 (external network) through the P-GW 9A and the service network 10 of the first carrier. Accordingly, it is possible to inhibit an inefficient data communication path from being formed when the home routed method is performed.

In addition, according to the embodiment, a P-GW address which is connected to the service network 10, which corresponds to the APN designated by the UE 1, is selected. Accordingly, it is possible to provide a network service, which is equivalent to the network service acquired when being connected to the home network, to the UE 1.

In addition, according to the embodiment, it is possible to form a data communication path which passes through the network facilities of the first carrier in the second carrier network, and thus it is possible to perform control and information collection, which are equivalent to those performed in the home network, for data communication.

Meanwhile, although the LTE network is described as an example of the 3GPP mobile communication system in the embodiment, a mobile communication system may be provided based on another wireless communication standard prescribed by the 3GPP or other standardization organizations. In addition, the network is not limited to a mobile phone network and may be a wireless LAN network. In brief, the wireless communication standard, which is suitable for the mobile communication network or which is conformed by the mobile communication network, is not limited.

It is possible to appropriately combine the configurations of the above-described embodiment. The above-described embodiment discloses supplements below. It is possible to appropriately combine the supplements below.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication control apparatus comprising:
a network interface configured to make the communication control apparatus be deployed in a specified core network operated by a specified carrier provider, the specified core network being one of a plurality of core networks, the specified carrier provider being one of a plurality of carrier providers, each of the plurality of core networks being operated by each of the plurality of carrier providers, each of the plurality of core networks being coupled to an external network, the specified core network in which a plurality of gateway apparatus are deployed, each of the plurality of gateway apparatus forwarding packets between the specified core network and the external network, the plurality of gateway apparatus including a specified gateway apparatus and at least one other gateway apparatus, the specified gateway apparatus being operated by the specified carrier provider, each of the at least one other gateway apparatus being operated by each of at least one other carrier provider of the plurality of carrier providers; and
a processor configure to:
identify, when a terminal requests to utilize the specified core network but has not subscribed to the specified core network, a gateway apparatus to make the terminal communicate with the external network using the packets, the gateway apparatus being identified from among the at least one gateway apparatus based on first information, the gateway apparatus being operated by another carrier provider to which the terminal has subscribed.

2. A communication control apparatus according to claim 1, wherein
the first information indicates an identifier of the another carrier provider to which the terminal has subscribed or an identifier of a tracking area including the another carrier provider, and
the first information is received from a management apparatus deployed in the specified core network.

3. A communication control apparatus according to claim 2, wherein
the processor is configured to transmit second information indicating the identified gateway apparatus to the management apparatus, in response to the first information.

4. A communication control apparatus according to claim 3, wherein
the processor is configured to:
receive third information identifying the terminal from the management apparatus,
transmit the third information to a server apparatus deployed in another core network operated by the another carrier provider, and
receive fourth information indicating whether to permit the terminal to use one of the at least one gateway apparatus operated by the another carrier provider, from the server apparatus.

5. A communication control apparatus according to claim 4, wherein
the server apparatus is configured to generate the fourth information based on the third information and pieces of subscriber information each of which is associated with each identifier of each terminal.

6. A communication control apparatus according to claim 4, wherein
the processor is configured to transmit second information indicating the identified gateway apparatus to the management apparatus, when the fourth information indicates that the terminal is permitted to use one of the at least one gateway apparatus operated by the another carrier provider.

7. A communication control apparatus according to claim 1, wherein
a core network operated by the another carrier provider corresponds to a home network of a network roaming, and
the specified core network corresponds to a visited network of the network roaming.

8. A communication control apparatus according to claim 1, wherein
the terminal is a wireless terminal, and
each of the plurality of core networks is each core network of each wireless communication network.

9. A communication control apparatus according to claim 1, wherein
each of the plurality of gateway apparatus is each serving gateway (S-GW) or each packet data network gateway (P-GW) of each long term evolution (LTE) network.

10. A communication control apparatus according to claim 1,
the external network is Internet.

11. A communication control apparatus according to claim 1,
the at least one other gateway apparatus is deployed using virtualized network function (VNF).

12. A communication control apparatus according to claim 1,
each of the plurality of gateway apparatus perform at least one of access control, bandwidth control and logging based on each policy of each of the plurality of carrier providers.

13. A communication system comprising:
a terminal; and
a communication control apparatus configured to:
be deployed in a specified core network operated by a specified carrier provider, the specified core network being one of a plurality of core networks, the specified carrier provider being one of a plurality of carrier providers, the specified core network in which a plurality of gateway apparatus are deployed, each of the plurality of gateway apparatus forwarding packets between the specified core network and an external network, the plurality of gateway apparatus including a specified gateway apparatus and at least one other gateway apparatus, the specified gateway apparatus being operated by the specified carrier provider, each of the at least one other gateway apparatus being operated by each of at least one other carrier provider of the plurality of carrier providers, and
identify, when the terminal requests to utilize the specified core network but has not subscribed to the specified core network, a gateway apparatus to make the terminal communicate with the external network using the packets, the gateway apparatus being identified from among the at least one gateway apparatus based on first information, the gateway apparatus being operated by another carrier provider to which the terminal has subscribed.

14. A communication control method comprising:
making the communication control apparatus be deployed in a specified core network operated by a specified carrier provider, the specified core network being one of a plurality of core networks, the specified carrier provider being one of a plurality of carrier providers, each of the plurality of core networks being operated by each of the plurality of carrier providers, each of the plurality of core networks being coupled to an external network, the specified core network in which a plurality of gateway apparatus are deployed, each of the plurality of gateway apparatus forwarding packets between the specified core network and the external network, the plurality of gateway apparatus including a specified gateway apparatus and at least one other gateway apparatus, the specified gateway apparatus being operated by the specified carrier provider, each of the at least one other gateway apparatus being operated by each of at least one other carrier provider of the plurality of carrier providers; and
identifying, when a terminal requests to utilize the specified core network but has not subscribed to the specified core network, a gateway apparatus to make the terminal communicate with the external network using the packets, the gateway apparatus being identified from among the at least one gateway apparatus based on first information, the gateway apparatus being operated by another carrier provider to which the terminal has subscribed.
